(19) United States
(12) Patent Application Publication
(10) Pub. No.: US 2010/0225013 A1
(43) Pub. Date: Sep. 9, 2010

(54) METHOD FOR PRODUCING OPTICAL MEMBER AND OPTICAL MEMBER FORMED BY THE PRODUCTION PROCESS

(75) Inventors: Noriko Eiha, Kanagawa (JP); Seiichi Watanabe, Kanagawa (JP); Masato Yoshioka, Kanagawa (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/675,422

(22) PCT Filed: Sep. 18, 2008
(86) PCT No.: PCT/JP2008/067365

§ 371 Date: Feb. 26, 2010

(30) Foreign Application Priority Data
Sep. 18, 2007 (JP) 2007-240875

(51) Int. Cl. B29D 11/00

(52) U.S. Cl. 264/1.1; 977/902

(57) ABSTRACT

A method for producing an optical member from a nanocomposite material which includes a thermoplastic resin containing inorganic fine particles is provided. The method includes:
a first step of preparing in a solution the thermoplastic resin containing the inorganic fine particles;
a second step of drying and solidifying the solution containing the prepared thermoplastic resin to produce the nanocomposite material having a specific surface area (surface area/volume) of 15 mm⁻¹ or more; and
a third step of heat-compressing the produced nanocomposite material to form the optical member in a desired shape.

### TECHNICAL FIELD

The present invention relates to a method for producing an optical material and to an optical member formed by the production method and, more particularly, to a technique of forming an optical material by using a nanocomposite material.

### BACKGROUND ART

In recent years, with the performance enhancement, size reduction, and reduction in production cost of optical devices such as mobile cameras and optical information-recording devices such as a DVD drive, a CD drive, and an MO drive, excellent materials and excellent production steps have strongly been desired with respect to optical members such as optical lenses and filters to be used for these devices.

In particular, plastic lenses are rapidly coming into wide use not only as lenses for spectacles but also as optical lenses because they are more lightweight and less breakable than lenses made of an inorganic material such as glass, because they can be processed into various shapes, and because they can be produced at a low cost. Along with this, it has been required to increase the refractive index of the material itself in order to reduce the thickness of the lens and to stabilize the optical refractive index against thermal expansion or change in temperature. As one technique for satisfying the requirements, there have been conducted various attempts to use as a lens material a nanocomposite material containing inorganic fine particles such as metal fine particles in a plastic resin to thereby improve optical refractive index and suppress change in optical refractive index due to change in temperature (for example, see JP-A-2006-343387, JP-A-2002-47425 and JP-A-2003-155415).

In the case of forming an optical member by using such nanocomposite material, it is necessary with an optical member which requires a high transparency that the particle size of the inorganic fine particles be smaller than at least the wavelength of light to be used. Further, in order to reduce attenuation of transmitted light intensity due to Rayleigh scattering, it is necessary to prepare nanoparticles having a uniform particle size of 15 nm or less and to disperse them.

As methods for preparing a nanocomposite material containing inorganic fine particles (nanoparticles) in a plastic resin, there can be considered the following methods:

(1) a method of directly introducing inorganic fine particles into a thermoplastic resin and injection-molding the mixture (JP-A-2006-299032);
(2) a method of mixing a monomer with inorganic fine particles, and then polymerizing the monomer to thereby be solidified within a mold (JP-A-2003-137912); and
(3) a method of dispersing inorganic fine particles and a resin in a solution, and then removing the solvent (JP-A-2003-147090).

However, of the above-described methods for producing nanocomposite materials, in the method (1) an uneven distribution of inorganic fine particle size is liable to occur and that stable optical performance is difficultly obtained. Also, an increase in the concentration of inorganic fine particles serves to enhance the effect of dispersing the inorganic fine particles, but it causes serious deterioration of fluidity of the resin, thus it becomes difficult to obtain the full effect of introducing the inorganic fine particles. This deterioration of fluidity starts to be caused when the addition amount of the inorganic fine particles is about 2% by weight, and the fluidity is clearly deteriorated when the addition amount is about 5% by weight.

With the method (2), polymerization of the monomer is accompanied by such a large contraction of volume that control of the resulting shape is difficult. Thus, it becomes difficult to secure accuracy required by a highly accurate optical part such as an image-forming lens.

With the method (3), it is possible to produce a lens having the highest quality but, in the actual production steps for producing an optical member, removal of the solvent takes a long time.

### DISCLOSURE OF THE INVENTION

An object of the invention is to provide a method for producing an optical member which can be molded in a comparatively short time with an accuracy appropriate as an optical part even when a nanocomposite material containing inorganic fine particles in a high density is used, and to provide an optical member formed by the production method.

A production method according to an aspect of the present invention involves at least two steps, i.e., a step of accelerating drying in which the surface area of a plastic solution containing dispersed therein inorganic nanoparticles is enlarged to dry, and a step of molding the nanocomposite material obtained by the step of accelerating drying into a desired optical member.

Specifically, the object of the invention can be attained by the following constitution.

(1) A method for producing an optical member from a nanocomposite material which includes a thermoplastic resin containing inorganic fine particles, the method including:

a first step of preparing in a solution the thermoplastic resin containing the inorganic fine particles;

a second step of drying and solidifying the solution containing the prepared thermoplastic resin to produce the nanocomposite material having a specific surface area (surface area/volume) of 15 mm⁻¹ or more; and

a third step of heat-compressing the produced nanocomposite material to form the optical member in a desired shape.

According to this method for producing an optical member, an optical member of a desired shape can be molded by heat-compressing a dry nanocomposite material (i.e., polymer containing inorganic fine particles) of 15 mm⁻¹ or more in specific surface area (surface area/volume) from a solution, and hence a lens with high quality can be produced without requiring a long time for removing the solvent. Also, the process facilitates shape control of an optical member to be produced, thus a transparent, highly accurate optical member with high quality being obtained.

(2) The method for producing an optical member according to (1), wherein the drying and solidifying is conducted to a droplet of the solution of the thermoplastic resin containing the inorganic fine particles.

According to this method for producing an optical member, a solution containing polymer containing inorganic fine particles is dried in a state of being sprayed as a mist of droplets. Thus, drying proceeds in a state where the surface of the entire solution is increased, which serves to largely shorten the time required for drying

(3) The method for producing an optical member according to (2), wherein the drying and solidifying is conducted by continuously ejecting the droplet of the solution through a spray nozzle in a pressurized state.

According to this method for producing an optical member, droplets of the solution can be continuously ejected in a pressurized state through a spray nozzle, and hence the solution can be sprayed in a mist state. Also, the size of the droplets can be reduced to a desired level by appropriately adjusting the diameter of the spray nozzle and the pressure upon applying pressure. Further, a comparatively large amount of droplets can be ejected in a short time, which is advantageous in the case of forming the nanocomposite material in a large amount.

(4) The method for producing an optical member according to (2), wherein the drying and solidifying is conducted by repeatedly ejecting the droplet of the solution through a nozzle of an inkjet head.

According to this method for producing an optical member, droplets of the solution can be repeatedly ejected through the nozzle of an inkjet head, there can be obtained a nanocomposite material having a small particle size by ejecting fine droplets. Also, since droplets having a uniform particle size can be ejected, all droplets are uniform with respect to the time necessary for drying, thus uneven drying scarcely occurring.

(5) The method for producing an optical member according to (4), wherein the ejecting of the droplet is repeated until an amount of the solution reaches a volume of at least one optical member to be formed by the heat-compressing in the third step.

According to this method for producing an optical member, the procedure of transferring a powder body can be omitted by, for example, directly ejecting the droplets into the heat compression mold.

(6) The method for producing an optical member according to any one of (2) to (5), wherein the droplet of the solution has a diameter of 0.5 mm or less.

According to this method for producing an optical member, there results an enormously large surface area of the entire ejected solution when the diameter of the droplets is 0.5 mm or less, thus the time required for drying being shortened to a practically sufficient short period.

(7) The method for producing an optical member according to any one of (1) to (6), wherein the drying and solidifying is conducted by freeze-drying the solution the solution of the thermoplastic resin containing the inorganic fine particles.

According to this method for producing an optical member, the degree of drying can be sufficiently enhanced by one freeze-drying procedure by freeze-drying the solution. As a result, the necessity of additional drying treatment such as vacuum drying after the drying is eliminated, thus the time required for the drying being shortened. Additionally, although the time required for drying in the case of conducting freeze-drying tends to be prolonged in comparison with other drying methods such as the spray drying method, such methods leave a comparatively large amount of the solvent in the dried product after the treatment. It is necessary to suppress the amount of the residual solvent in the nanocomposite material to be used for forming, for example, an optical lens at a low level. However, in the case of employing other drying methods such as the spray drying method, it is necessary to further remove the residual solvent even after the drying treatment. In the case of conducting freeze-drying, however, the amount of the residual solvent reaches a sufficiently low level at the point of completion of the freeze-drying step, and hence further drying treatment is not necessary, thus the time required for the entire step being shortened. Further, in comparison with the spray drying method, the freeze-drying method less generates static electricity and, therefore, causes less contamination with dust. Also, since the surface area becomes larger than in the common concentration drying, handling properties in the subsequent step are improved.

(8) The method for producing an optical member according to (7), wherein the drying and solidifying is conducted by: weighing an enough amount of the solution of the thermoplastic resin containing the inorganic fine particles to form one optical member; and freeze-drying the solution in a mold having a smaller inner size than that of the optical member.

According to this method for producing an optical member, the solution is weighed and poured into a mold having a smaller inner size than the external shape of one optical member and then freeze-dried, and hence handling properties of the material are so much improved that productivity is improved, and that possibility of contamination with dust or the like is reduced. Thus, optical members having higher quality can be produced. In addition, since the external shape after freeze-drying is less than the diameter of the lens of the final shape, an enough deformation allowance can be obtained in the latter heat-compressing step to permit molding with high accuracy.

(9) The method for producing an optical member according to any one of (1) to (8), wherein the heat-compressing of the nanocomposite material is conducted in vacuum state, in a carbon dioxide gas, or in a nitrogen gas.

According to this method for producing an optical member, the dry nanocomposite material formed in the second step is heat-compressed in a vacuum state or in the atmosphere of a carbon dioxide gas or a nitrogen gas each having a high solubility in the resin, and hence a high-quality optical member not containing residual air can easily be produced. That is, since carbon dioxide gas or nitrogen gas has such a high solubility in a resin that, in the case of heat-compressing the dry composite material, the atmospheric gas dissolves, if remains in the dry nanocomposite material, into the resin and does not cause failures such as transfer failure or optical strain. Also, when the heat-compressing procedure is conducted in a vacuum state, residual air is not generated, thus the aforesaid failures being prevented. On the other hand, in the case of forming an optical member by heat-compressing in the air the dry nanocomposite material formed in the second step, the residual air is entrapped within the resin material and, upon heat-compressing, failures such as transfer failure or optical strain are liable to occur.

(10) The method for producing an optical member according to any one of (1) to (9), wherein the optical member is a lens or a lens precursor (preform).

According to this method for producing an optical member, a lens or a lens precursor (perform) of a nanocomposite material having a large refractive index can be formed in a shorter time and at a lower cost than before. That is, a lens unit having the same optical performance can be formed in a smaller size than before.

(11) An optical member formed by a method for producing an optical member according to any one of (1) to (10).

According to this method for producing an optical member, an organic member comprising a nanocomposite material having a large refractive index can be formed in a shorter time and at a lower cost than before. That is, an optical unit of the same optical performance can be formed in a smaller size than before.

### ADVANTAGEOUS EFFECTS

According to a method for producing an optical member in an aspect of the invention, there can be formed an optical member of a desired shape by heat-compressing a nanocomposite material (i.e., polymer containing inorganic fine particles) taken out from a solution in a state of 15 mm⁻¹ or more in specific surface area, and hence a high-quality, highly accurate optical member can be formed without taking a long period of time for removing the solvent. Also, the process facilitates shape control of the optical member, thus designing freedom being increased. In addition, the process can contribute to downsizing of an optical unit and enhancement of image resolution.

### BRIEF DESCRIPTION OF THE DRAWINGS

FIG. 1 is a flow chart showing fundamental procedures regarding a method for producing an optical member;

FIG. 2 is a schematic view showing a structure of a spray drying apparatus which can be utilized in a production step for forming a powdery nanocomposite material from a solution;

FIG. 3 is a flow chart showing specific procedures regarding the production process in the case of utilizing the spray drying apparatus shown in FIG. 2;

FIG. 4 is a schematic view showing a structure of a vacuum drying apparatus;

FIG. 5 is an illustration showing an example of steps (a), (b), and (c) for forming a lens from the powdery nanocomposite material;

FIG. 6 is a schematic view showing a structure of one example of an inkjet mechanism;

FIG. 7 is an illustration (a), (b), and (c) showing an inside structure and operation of the inkjet head shown in FIG. 6;

FIG. 8 is a schematic view showing a structure of one example of a freeze-drying apparatus;

FIG. 9 is a flow chart showing procedures of the freeze-drying method;

FIG. 10 is an illustration showing a state of the nanocomposite material formed and frozen in the freeze-drying apparatus;

FIG. 11 is an illustration showing a manner of forming a preform by the freeze-drying apparatus;

FIG. 12 is an illustration (a), (b), and (c) showing an operation example of a heat-compressing step in the case of forming a lens from the preform;

FIG. 13 is a schematic view showing a structure of one example of a spray type freeze-drying apparatus;

FIG. 14 is a graph showing the relation between an amount of the residual solvent during drying treatment and an elapsed time; and

FIG. 15 is an illustration showing a mechanism how the drying time is shortened in the freeze-drying.

### BEST MODE FOR CARRYING OUT THE INVENTION

Exemplary embodiments of a process method for producing an optical member in the invention and optical members formed by this production method will be described in detail below by reference to drawings.

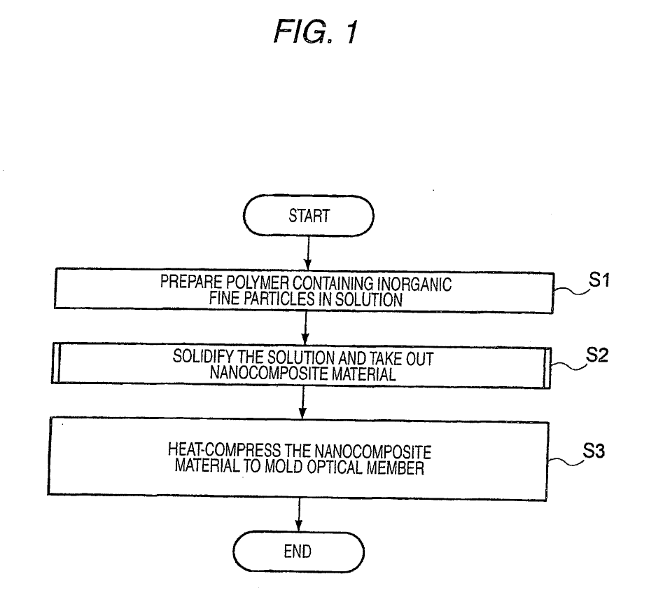

Fundamental procedures relating to the method of this embodiment for producing an optical member are shown in FIG. 1. The production process can be realized by conducting fundamentally three steps of S1, S2, and S3.

First, in the first step S1, a material constituting a nanocomposite material is formed as a solution. Additionally, the term “nanocomposite material” as used herein means a material obtained by mixing inorganic fine particles with a thermoplastic resin in a solvent such as an organic solvent, and then removing the solvent from the thus-prepared nanocomposite solution, and detailed description on the nanocomposite material will be given hereinafter. That is, in the step S1, in order to form a polymer (thermoplastic resin) containing inorganic fine particles uniformly dispersed therein, the polymer is prepared in a liquid which functions as a solvent. Additionally, the polymer containing the inorganic fine particles may be either in a state where the inorganic fine particles are dispersed in the polymer or in a state where the inorganic fine particles are being bound to the polymer.

Next, in the step S2, a nanocomposite material is formed from the solution obtained in the preceding step S1. That is, the solvent is evaporated by drying the solution to thereby solidify the polymer containing the inorganic fine particles, followed by taking out the solidified polymer as a dried nanocomposite material. The nanocomposite material thus taken out is adjusted to have a specific surface area of 15 mm⁻¹ or more. The specific area is a parameter represented by the surface area of a substance to volume of the substance. A smaller specific surface area leads to a smaller surface area contributing to drying, thus the drying time being prolonged. The residual solvent amount which is practically required is 2 wt % by weight or less and, in order to dry to that level, a specific surface area of less than 15⁻¹ mm leads to a prolonged drying time, thus not being practical. Accordingly, the specific surface area is appropriately 15 mm⁻¹ or more, preferably 30 mm⁻¹ or more, still more preferably 100⁻¹ mm or more.

In the step 3, the nanocomposite material obtained in the preceding step S2 is processed to mold an optical member such as a lens. Specifically, an optical member is molded by filling a specific amount of the nanocomposite material in an appropriate mold and compressing the nanocomposite material within the mold under heating.

Incidentally, in the production steps shown in FIG. 1, it is the step 2 that requires a special technique. That is, under the present circumstances, it has taken an extremely long time to obtain a material (nanocomposite material) of an optical member from the solution obtained in the step S1. In short, it takes quite a long time to dry the solution, and in case when drying is insufficient, there result insufficient characteristic properties, thus sufficient functions as an optical member not being exhibited.

This embodiment provides a novel production method which solves such a matter. A specific example of practical production steps will be described below.

### First Embodiment

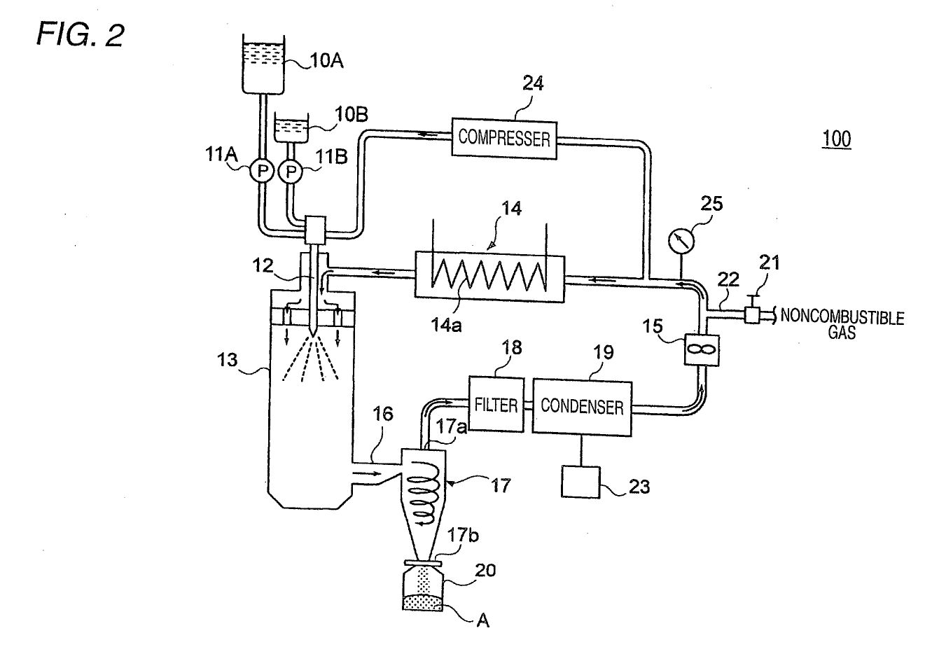

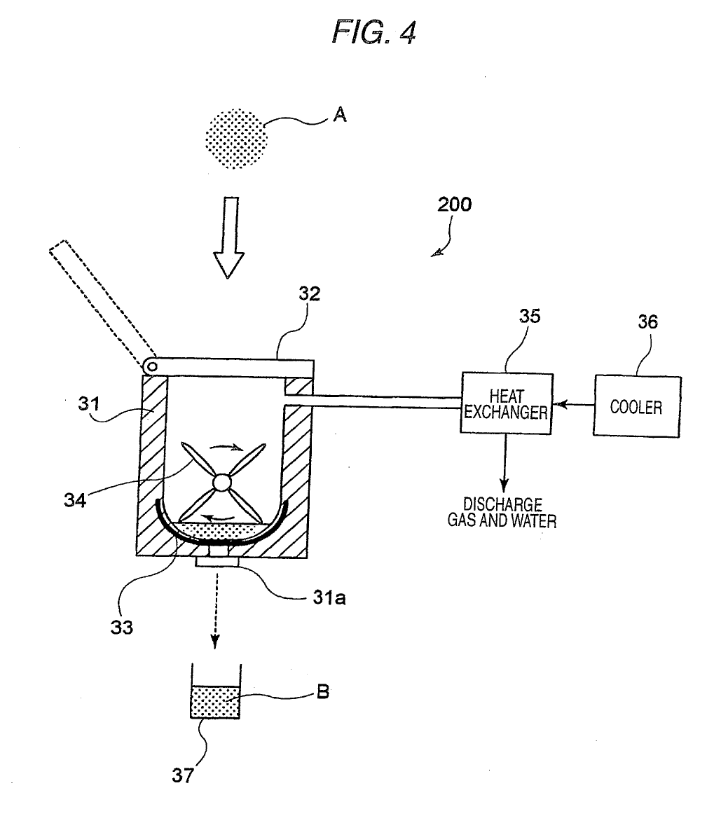

In the first embodiment, in order to conduct drying of the solution in the step S2 shown in FIG. 2, it is assumed to utilize a spray drying apparatus 100 of the constitution shown in FIG. 2 as one example. In the case of utilizing this spray drying apparatus, the solution is introduced into a high-temperature gas as finely atomized droplets to dry. In short, the solution is dried as droplets having an increased surface area, and hence the time required for drying it can be markedly shortened. However, the drying degree of the powdery nanocomposite material obtained by the spray drying apparatus treatment is not necessarily sufficient, and further drying is conducted by using a vacuum drying apparatus (see FIG. 4 to be described hereinafter).

The spray drying apparatus 100 shown in FIG. 2 is equipped with a solution tank 10A for storing a solution containing a nanocomposite material; a solution-feeding pump 11A; a solution tank 10B; a solvent-feeding pump 11B; a spray nozzle 12 for forming the solution into droplets; a drying chamber 13 for circulating the spray of the solution; a heating apparatus 14 connected to the drying chamber 13 and having a heater 14a; and a fan 15 for feeding air to the heating apparatus 14 to generate a warm air and introducing the warm air into the drying chamber 13. Also, the spray drying apparatus 100 is equipped with a cyclone chamber 17 connected to the drying chamber 13 via a connecting pipe 16; a filter 18 connected to an exhaust opening 17a of the cyclone chamber 17; a condenser 19; and a sealed vessel 20 connected to a powder taking-out opining 17b and for recovering a produced powdery nanocomposite material A. Further, a noncombustible gas-feeding path 22 for feeding a noncombustible gas such as nitrogen is connected to the drying chamber 13 via a valve 21. The noncombustible gas-feeding path 22 may be connected to the upstream side of the fan 15. Also, a solvent-recovering section 23 for recovering the solvent liquefied by condensation is connected to the condenser 19.

A compressor 24 is connected to the spray nozzle 12 to adjust conditions of spraying the solution. Also, an oxygen concentration measuring meter 25 is provided on the way of the flow path to the drying chamber 13 by the fan 15 to monitor the oxygen concentration within the flow path. Additionally, a solvent-feeding system of the solvent tank 10B and the solvent-feeding pump 11B may be of a constitution in which the solvent tank 10B is connected to the flow path between the solution tank 10A and the solution-feeding pump 11A via flow path-changing means to share the solution-feeding pump 11A for feeding.

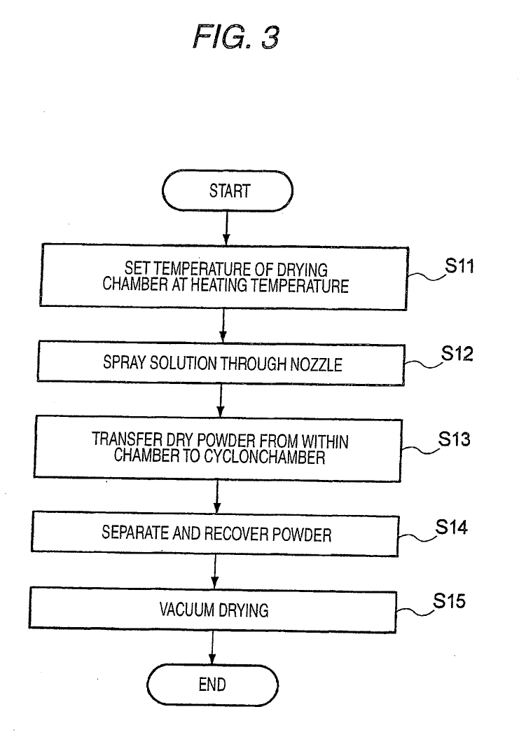

The procedures of the production step (corresponding to S2 in FIG. 1) in this embodiment are shown in FIG. 3. The procedures will be described below.

First, the atmosphere within the drying chamber 13 and the cyclone chamber 16 is replaced with a noncombustible gas such as nitrogen. The drying chamber 13 and the cyclone chamber 17 are filled with the noncombustible gas by opening the valve 21 on the noncombustible gas-feeding path 22. As the noncombustible gas, nitrogen, carbon dioxide, a rare gas, or the like can be used. Of these, nitrogen is desirable in view of price and harmlessness to human beings. In particular, nitrogen or carbon dioxide is more preferred because they are easily soluble in a resin.

Then, the condenser 19 is operated to prevent condensation of steam within the drying chamber 13 and the cyclone chamber 17. The temperature of the condenser 19 is set at a temperature between the boiling point of the solvent in the solution and the melting point thereof.

Then, the heater 14a of the heating apparatus 14 is turned ON to feed warm air into the inner space of the drying chamber 13. Thus, the temperature within the drying chamber 13 is adjusted to a desired temperature (S11).

After the atmospheric temperature within the drying chamber 13 reaches the desired temperature level, the solvent-feeding pump 11B is operated to spray the solvent through the spray nozzle 12 into the inside of the drying chamber 13 to adjust spraying condition. The solvent can be used for other uses, i.e., for adjusting the solution-feeding amount and for confirming stability of the temperature. Additionally, as the solvent, there can be utilized those organic solvents which can dissolve the composite material, such as hexane, benzene, diethyl ether, chloroform, tetrahydrofuran, methylene chloride, acetone, MEK (methyl ethyl ketone), DMAc (Dimethylacetamido), toluene, ethyl acetate, or dioxolan. Additionally, these may be used independently or as a mixture thereof by mixing them, such as a mixed solvent of toluene and ethanol. Solvents having a boiling point of 60° C. or higher are particularly preferred.

Then, the solution-feeding pump 11 is operated to spray the solution containing the nanocomposite material through the spray nozzle 12 into the inside of the drying chamber 13 (S12). Here, preferred spraying conditions are as follows.

Atmospheric temperature of spraying zone: The lower limit temperature is preferably equal to the boiling point of the solvent −50° C. or higher, more preferably equal to the boiling point of the solvent −30° C. or higher, still more preferably equal to the boiling point of the solvent or higher. The upper limit temperature is preferably equal to ((the heat-resistant temperature of the material or the glass transition temperature Tg of the resin)+50° C.) or lower, preferably (Tg+30° C.) or less, more preferably (Tg+10° C.) or less. In case when the lower limit temperature is lower than the boiling point of the solvent, sufficient drying cannot be carried out whereas, in case when the upper limit temperature exceeds the glass transition temperature of the resin, the powdery nanocomposite material is softened and becomes liable to weld to each other, thus no good powder body being obtained.

Concentration of the solution: The concentration of the solid components is preferably 50% by weight or less, more preferably from 10% by weight to 30% by weight. In case when the concentration of the solid components is too low, the amount of the solvent to be removed by drying becomes so large that productivity is reduced whereas, in case when too high, the viscosity of the solution increases so much that it becomes impossible to form droplets in the nozzle portion. Additionally, the solution may be cooled by cooling water or the like till it reaches the vicinity of the nozzle.

In the manner as described above, the solution is sprayed into the inside space of the drying chamber 13 in the form of fine droplets (the diameter of the droplets being preferably 0.5 mm or less) through the opening at the tip of the spray nozzle 12 (S12). When the diameter of the droplets is adjusted to be 0.5 mm or less, the surface area of the entire solution ejected becomes so large that the time required for drying can be shortened to a practically sufficient level.

The warm air is fed to the cyclone chamber 17 via the connecting pipe 16 together with the droplets while stirring the oil droplets within the drying chamber 13 (S13). Within the cyclone chamber 17, a cyclone is formed in the inner space, and a powder body of the dried and solidified nanocomposite material and a gas are separated from the droplets. The gas is discharged through the exhaust opening 17a and is allowed to pass through the filter 18 to thereby remove small powder body not having been collected by the cyclone, and the solvent vapor is condensed within the condenser 19. The solvent vapor-free gas is returned to the fan 15 and the heating apparatus 14 and is again heated before being fed to the drying chamber 13. On the other hand, the powdery nanocomposite material separated in the cyclone chamber 17 is recovered within the sealed vessel 20 (S14).

As described above, the solution fed from the solution-feeding pump 11 is sprayed into the inside of the drying chamber 13 as fine droplets, and hence they are dried in a short time to form particles independent from each other, with each particle corresponding to each droplet, and are taken out into the sealed vessel 20 as a nanocomposite material (before drying) A.

However, there exists the case where the degree of drying of the nanocomposite material A recovered in the step 14 is still insufficient. Thus, a further drying treatment is conducted in the subsequent step S15 by using, for example, a vacuum drying apparatus.

In this vacuum drying treatment, an oil-sealed rotary vacuum pump is preferably used. Here, it is preferred to conduct the drying treatment under high vacuum degree. Batchwise drying treatment permits large-scale treatment at one time.

The pressure upon vacuum drying is 10 Pa or less, preferably 1 Pa or less, more preferably 0.1 Pa or less. Vacuuming is preferably conducted by using an oil-sealed rotary vacuum pump in the points that it has a high durability and that it can be repeatedly used with ease.

Also, the temperature T upon vacuum drying is (room temperature)<T<Tg (glass transition temperature), more preferably (room temperature+10° C.)<T<(Tg−10° C.). As the temperature becomes higher, there results a larger drying speed but, in case when the temperature is higher than Tg, powder particles might weld to each other to reduce the surface area and might inversely delay drying. As to heating manner, radiative heating is preferred because it involves no heating unevenness. Also, a constitution may be employed, in which heating unevenness is removed by rotation of an agitating blade. In this case, however, it is preferred to remove static electricity before opening the chamber after completion of the drying.

FIG. 4 shows one example of a constitution of the vacuum drying apparatus. This vacuum drying apparatus 200 is equipped with a drying vessel 31, a lid 32, a heating jacket 33, an agitating blade 34, a heat exchanger 35, and a cooling apparatus 36. With this vacuum drying apparatus 200, the nanocomposite material (A in FIG. 2) to be dry-treated is introduced into the inside space of the drying vessel 31 by opening the lid 32 positioned at the upper portion of the drying vessel 31. The agitating blade 34 is rotated in the inside space of the drying vessel 31 for accelerating drying of the introduced nanocomposite material to thereby stir the nanocomposite material. Also, the introduced nanocomposite material is heated by a heating jacket 33 provided around the drying vessel 31.

The inside space of the drying vessel 31 can be kept in an air-tight state by closing the lid 32. The air remaining in the inside of the drying vessel 31 is sucked by the oil-sealed rotary vacuum pump (not shown) connected via the heat exchanger 35. Further, the air sucked to the side of the heat exchanger 35 is cooled and condensed by means of a condenser 36 to liquefy the evaporated solvent and increase the vacuum degree. Thus, the inside space of the drying vessel 31 is kept under vacuum condition with reducing the amount of evaporated solvent.

The nanocomposite material B sufficiently dried in the inside of the drying vessel 31 is recovered on a tray 37 through a discharge outlet 31a positioned under the drying vessel 31.

Additionally, an appropriate treatment for removing static electricity is preferably carried out in either, or both, of during and after vacuum drying.

Incidentally, the material may be concentrated before conducting the above-described spray drying, by centrifugation, pressure filtration, precipitation such as reprecipitation, or the like. The liquid viscosity upon spray drying is preferably 1000 cP or less, more preferably 500 cP or less, still more preferably 100 cP or less (the liquid viscosity being able to be adjusted by controlling the concentration of the solution).

After producing the powdery dry nanocomposite material B as described above, this dry nanocomposite material B is used as a filling material and heated and compressed in the step S3 shown in FIG. 1 to mold an intended optical member.

In this example, the dry nanocomposite material B is introduced in the powdery state into the lens-molding apparatus 300, and is then subjected to a heating step and a compressing step to mold into an optical lens (or a preform, a lens precursor, of a shape approximate to a lens shape). In the case of molding a preform, the preform is fanned into a final product of a lens by subjecting it to a press-molding step. Also, with the preform, a lower shape accuracy than with a lens may be permitted. Namely, it suffices to finish the preform so as to have a shape approximate to the final optical member, and each metal mold for a lens-molding apparatus is not required to have a high accuracy, which serves to reduce the production cost of the metal mold. Also, in the case of molding a preform, the curvature of the preform is preferably made larger than that of a final shape when molding a convex surface or, inversely, is preferably made smaller than that of a final shape when molding a concave surface. Thus, the resulting lens formed as a final shape can be molded with higher accuracy.

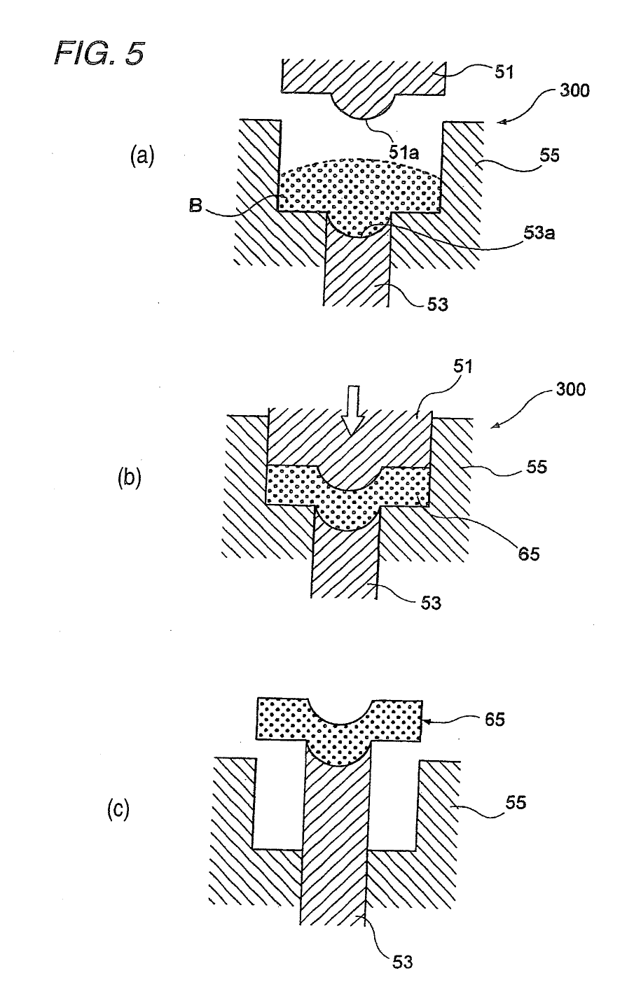

Next, an example of steps for molding a lens from the dry nanocomposite material B is shown in FIG. 5.

As is shown in FIG. 5, a lens-molding apparatus 300 has at least an upper metal mold 51, a lower metal mold 53, and an outer metal mold 55, with the lower surface 51a of the upper metal mold 51 and the upper surface 53a of the lower metal mold 53 each being formed so as to have the shape of the final product of the optical member 65.

To illustrate specific procedures, as is shown in FIG. 5, the dry nanocomposite material B is introduced as a powder onto the lower metal mold 53 disposed within the outer metal mold 55 (FIG. 5(a)), and is pressed between the upper metal mold 51 and the lower metal mold 53 while being heated to mold into an optical member of a lens 65 (FIG. 5(b)). Then, after cooling in the pressed state, the lower metal mold 53 is moved upward to open the upper metal mold 51 and the lower metal mold 53. Thus, the compression-molded lens 65 is taken out (FIG. 5(c)).

Regarding the compression molding conditions, the metal mold temperature, for example, is set within the range of from the glass transition temperature Tg of the nanocomposite material to (Tg+150° C.), preferably from Tg to (Tg+100° C.). The pressure to be applied is in the range of from 0.005 to 100 kg/mm², preferably from 0.01 to 50 kg/mm², still more preferably from 0.05 to 25 kg/mm². The pressing speed is from 0.1 to 1000 kg/sec, and the pressing time is from 0.1 to 900 sec, preferably from 0.5 to 600 sec, still more preferably from 1 to 300 sec. The timing of starting pressing may be before heating or immediately after heating or, further, may be after a period of time in order to uniformly heating the material (i.e., uniformly heating the dry nanocomposite material B to the interior thereof). Also, since the lens 65 contracts upon cooling, the shape of the metal mold (optical function-transferring surfaces 51a and 53a) can be transferred to the optical member 67 with higher accuracy by conducting pressing in harmony with the cooling. However, when cooled to a temperature equal to or lower than the glass transition temperature Tg, the shape of the lens does not change any more, and hence it is preferred to release the metal molds and take out the molded product. Also, in order to shorten the cycle, the heating-cooling treatment is preferably conducted in a shorter time, and there can be preferably employed a heating system of, for example, high frequency induction heating. Additionally, as to the timing of pressing, it is preferred to press prior to heating in order to reduce the amount of residual gas.

After the above-described steps, the dry nanocomposite material B formed as a powder body from the solution is formed into a lens having been processed to have a desired shape with high accuracy, or a lens precursor (preform). As is described above, an optical member of a desired shape is molded by heat-compressing the nanocomposite material (i.e., polymer containing inorganic fine particles) having been taken out as a powder body from the solution, and hence an optical member with high quality and high accuracy can be formed without taking quite a long time for removal of the solvent. In addition, it becomes easier to control the shape of the optical member, with design freedom being enhanced. Further, since the nanocomposite material has such a high refractive index that an optical member with high refractive index and high quality can be obtained with ease, and the material can contribute to downsizing of an optical member and enhancement of image resolution.

Additionally, in the case where the lens-molding apparatus 300 shown in FIG. 5 is an apparatus for forming a preform, the preform is molded into a lens by heat-pressing in a similar compression-molding machine equipped with a metal mold capable of providing a desired final shape.

Forming a lens of a final shape via the preform thereof provides the following advantages.

That is, although it requires a high technique to weigh the fine-powdery dry nanocomposite material B with high accuracy in a short time, forming a final product via the preform thereof permits rough measuring of weight (or volume) of the dry nanocomposite material B, followed by introducing it into a compression-molding apparatus and compression-molding it to give a desired thickness. Here, with the molded preform, accurate control of weight (volume) is not necessary, and it suffices that the powder body is at least converted to a transparent solid body. In short, all that is required is to introduce the dry composite material B into the inside of the metal mold of the compression-molding apparatus without particular attention to the weight (volume) of the material. Even when an excess dry nanocomposite material B is introduced, this excess portion can be received by providing a portion for receiving the excess portion in the lens flange portion, thus the preform-forming step being simplified.

The finished preform may be subjected, as needed, to a processing of cutting off the peripheral portion of the flange portion to thereby approximate the shape to the final shape of a lens or may be subjected to a latter-stage press-molding step to thereby finish into a lens shape, thus processing accuracy being enhanced. Thus, the shape of the preform can be approximated to that of a lens with high accuracy and high stability.

### Modified Example 1

Various modification examples can be considered with respect to the above-described method for producing an optical member. For example, upon drying the solution in the step S2 shown in FIG. 1, a nanocomposite material can also be obtained by utilizing an inkjet mechanism employed in an inkjet printer or the like in place of utilizing the spray drying apparatus of the constitution shown in FIG. 2, to thereby atomize the solution into fine droplets and eject them.

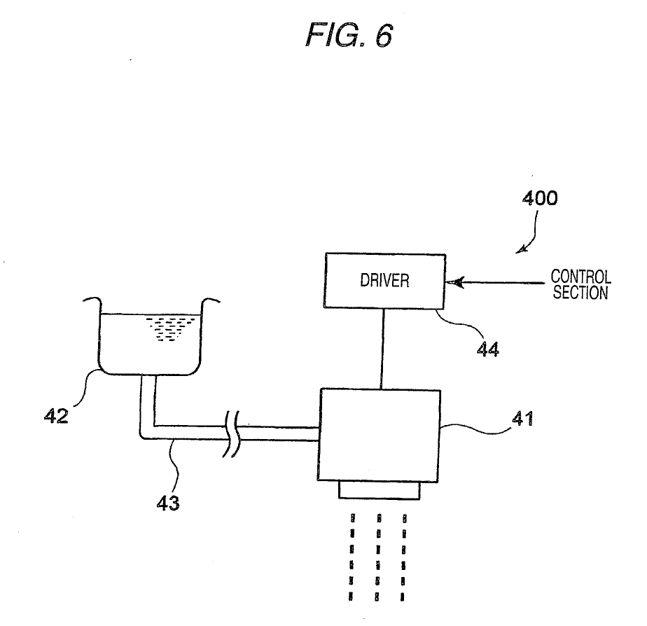

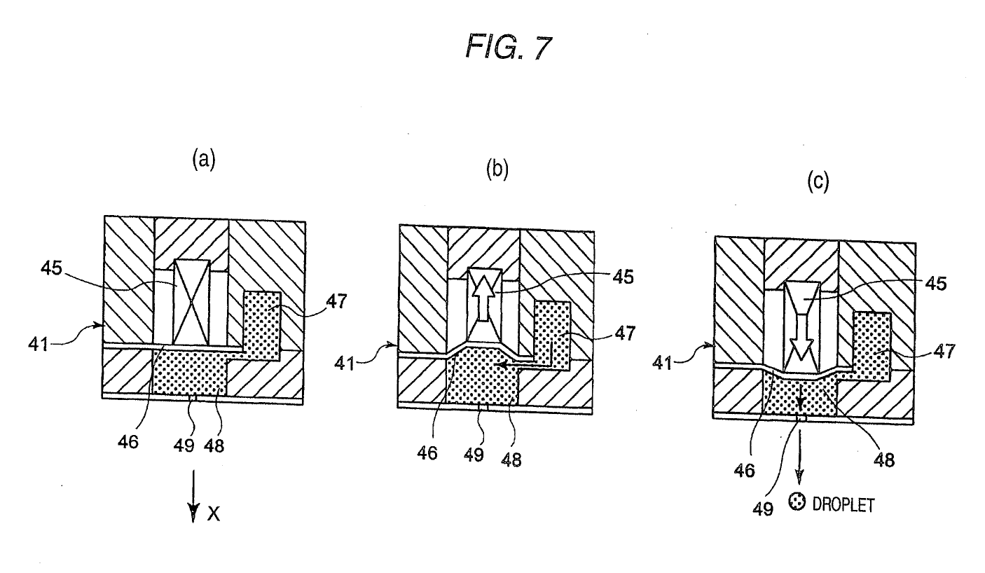

An example of a constitution in the case of utilizing the inkjet mechanism is shown in FIGS. 6 and 7.

As is schematically shown in FIG. 6, the inkjet mechanism 400 is constituted by an inkjet head 41; a tank 42 for storing a solution; a tube 43 for feeding the solution from the tank 42 to the inkjet head 41; and a driver 44 for driving ejection of droplets by means of the inkjet head 41.

Also, as FIG. 7 shows an example of an operation principle of the inkjet mechanism, a piezo element 45 which is a piezoelectric element, a flexible diaphragm 46 connected to one end of the piezo element 45, a solution-feeding part 47 constituting a solution-feeding line, a pressure chamber 48 into which the solution is introduced from the solution-feeding part 47, and a nozzle 49 formed as an opening in part of the pressure chamber 48 are provided as one-series constitution within the inkjet head 41. A plurality of the above-described one-series constitutions are provided in the inkjet head 41.

In the above-described constitution, the solution filled in the tank 42 is introduced into the inkjet head 41 through the tube 43. Starting from the initial state shown in FIG. 7(a), the piezo element 45 is allowed to contract, as shown in FIG. 7(b), to suck the diaphragm 46 so as to generate a negative pressure within the pressure chamber 48, thus the solution being introduced from the solution-feeding part 47 into the pressure chamber 48. Then, as is shown in FIG. 7(c), the piezo element is stretched to push out the diaphragm 46 to thereby apply pressure to the pressure chamber 48. Thus, a droplet is ejected through the nozzle 49 to form a droplet. Droplets of the solution are continuously formed in an amount corresponding to the number of times of stretching and contraction caused by repeatedly conducting this operation.

This inkjet head 41 can produce droplets having a size sufficiently smaller than that of the droplets produced by the spray nozzle 12 used in the spray drying apparatus 100, thus drying of the solution being surely accelerated. Additionally, the diameter of the droplets is desirably 0.1 mm or less.

In the above illustration, an on-demand type inkjet head using a piezo element is used. However, a continuous type inkjet head or a thermal system inkjet head not using the piezoelectric element such as a piezo element may be used as well instead of the on-demand type inkjet head.

Ejecting the solution as fine droplets by utilizing the inkjet mechanism serves to increase the surface area of the droplets, and hence the time required for drying can be shortened in comparison with the case of utilizing the spray drying apparatus. In the case of utilizing the spray drying apparatus, there result droplets having non-uniform droplet sizes, whereas a large amount of droplets can be sprayed in a short time. On the other hand, in the case of ejecting droplets by utilizing the inkjet mechanism, it is difficult to eject a large amount of droplets in a short time, whereas the size of the droplets can be accurately controlled to thereby eject droplets with a uniform droplet size. Therefore, in the case of forming a powdery nanocomposite material by utilizing the inkjet mechanism, the particle size of the resulting powder body can be made uniform, which leads to uniform drying time for every droplet. Thus, uneven drying difficultly takes place. The amount of ejected droplets can be increased by increasing the number of the nozzles in the inkjet head, whereby a large amount of droplets can be obtained with ease.

Here, a method of metering the nanocomposite material with high accuracy by counting the amount of droplets upon ejecting the solution as droplets utilizing the inkjet mechanism will be illustrated below.

According to this method, the amount of ejected droplets can be counted, and hence the amount of the material to be press-molded in the latter stage can accurately be set.

Specific practical procedures of this method are as follows.

(1) Droplets are ejected into a high-temperature gas by the inkjet mechanism while counting the ejection amount, and the thus-obtained dry nanocomposite material is deposited in a vessel or on a tray.
(2) When the amount of the nanocomposite material deposited in the vessel or on the tray reaches the volume of one lens to be formed, the vessel or the tray is exchanged for a novel one (alternatively, the content may be transferred to another vessel or tray).
(3) The nanocomposite material is further dried in a vacuum drying apparatus.
(4) The dried nanocomposite material is placed in a molding mold, followed by heat-compressing.

The vessel for depositing the nanocomposite material formed by ejecting the droplets may be a metal mold for molding. In this case, metering accuracy is not deteriorated by transferring the nanocomposite material, thus molding being able to be conducted with high accuracy. Additionally, in the case of directly depositing in the metal mold, the metal mold is preferably a metal mold for molding a preform. Use of the metal mold for molding a preform eliminates the necessity of making plural metal molds which are expensive.

Additionally, an appropriate treatment for removing static electricity is preferably carried out in either, or both, of during and after vacuum drying.

Incidentally, upon molding an optical member in the step S3 shown in FIG. 1 by heating and compressing the dry nanocomposite material B, there is the possibility that molding is conducted in the state where molecules of the air remaining in the space between the particles of the nanocomposite material are entrapped in the interior of the material, which might lead to generation of failures such as transfer failure of the mold and optical strain and, further, generation of voids.

In order to avoid generation of such failures, it is necessary to sufficiently remove the air between the particles upon molding an optical member from the dry nanocomposite material B. Therefore, molding of an optical member by heat-compressing is preferably conducted in a vacuum state. The vacuum degree in this occasion is from 0.01 kPa to 50 kPa, preferably from 0.1 to 10 kPa. A higher atmospheric pressure is liable to generate the above-described failures, whereas a lower atmospheric pressure leads to reduction in productivity.

On the other hand, upon molding an optical member from the dry nanocomposite material B, the molding treatment can be conducted under the atmosphere filled with, for example a carbon dioxide (CO₂) gas or a nitrogen (N₂) gas, in place of establishing the vacuum-state atmosphere.

A carbon dioxide gas or a nitrogen gas has a high solubility for a resin material, and hence, upon conducting compression molding in an atmosphere filled with a carbon dioxide gas or a nitrogen gas, their molecules are not entrapped and do not remain in the material as is different from the air, thus generation of failures such as transfer failure of the mold or optical strain being suppressed. In addition, it is easier to produce a carbon dioxide gas atmosphere or a nitrogen gas atmosphere in comparison with the vacuum atmosphere, and hence the working time required for the compression molding can be shortened. Additionally, as to the solubility for a resin material, the solubility of a carbonic acid gas is higher than that of a nitrogen gas and, therefore, the carbonic acid gas atmosphere is preferred as the atmosphere to be employed in the step of compression-molding the dry nanocomposite material B.

### Second Embodiment

Next, a second embodiment of the process of the invention for producing an optical member will be illustrated below.

In this embodiment, drying of the solution in the step S2 shown in FIG. 1 is conducted by employing a freeze-drying method in place of the method of forming a powdery nanocomposite material from the droplets of the solution. This freeze-drying method is a method of obtaining a massive nanocomposite material by vacuum-drying the solution to form a solid product and taking out it.

Generally, in employing the freeze-drying method, the solution is dried without forming droplets, and hence the time required for drying becomes comparatively long in comparison with the spray drying method and the inkjet drying method due to the difference of surface area in a wet form. However, at the point of completion of this freeze-drying, the freeze-dried product is in a state of being dried to about the same level as with the dry nanocomposite material B obtained by further dry-treating the nanocomposite material A. Accordingly, it is not necessary to conduct, for example, the vacuum-drying step S15 shown in FIG. 3, and the time required for obtaining a dry nanocomposite material which can be utilized for the production of an optical member can be sufficiently shortened even when employing the freeze-drying method.

Here, the freeze-drying method will be described below.

FIG. 8 is a schematic view showing one example of the constitution of a freeze-drying apparatus. This freeze-drying apparatus 500 has a vacuum chamber 71, a cold trapping part 72, and a freezer 73. A tray 74 for storing a solution and a heater 75 for heating the tray 74 are disposed within the vacuum chamber 71. A freezing pipe 76 is disposed within the cold trapping part 72, and the pressure inside the cold trapping part 72 can be reduced by means of a vacuum pump 77. Also, the freezer 73 has a heat exchanger 78 which discharges heat from the freezing pipe 76 to cooling water.

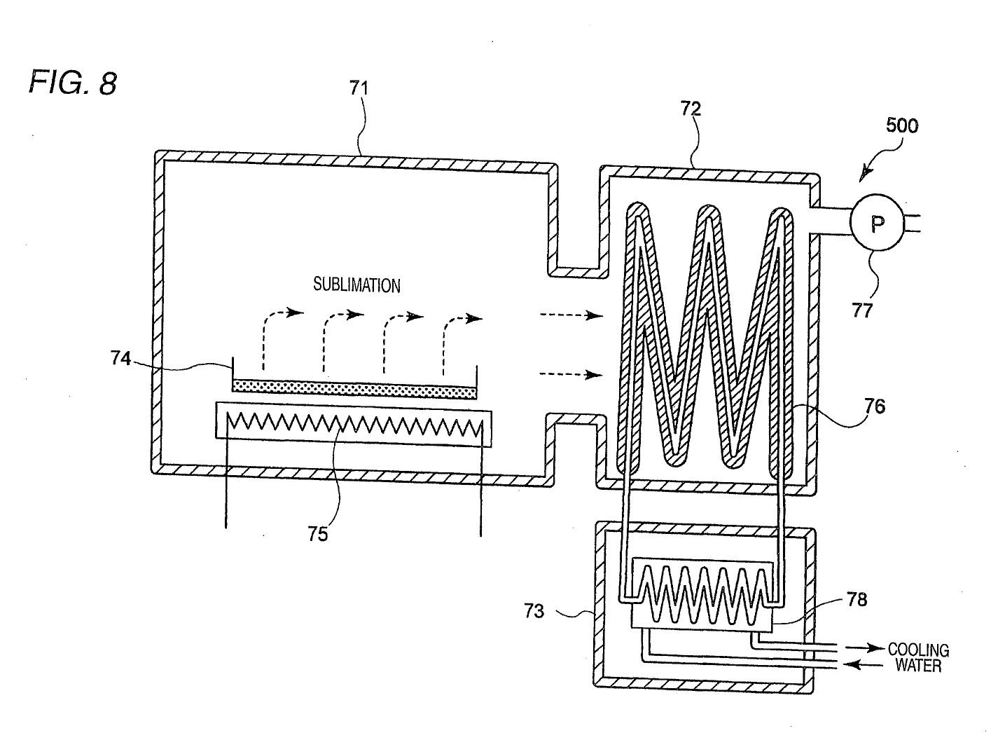

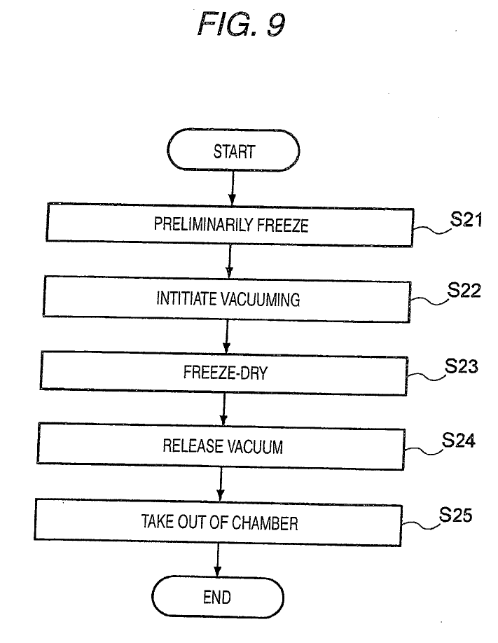

In this embodiment, a treatment corresponding to the step S2 in FIG. 1 is conducted by using the freeze-drying apparatus 500 having the above-described constitution. Treatment procedures will be illustrated below according to the procedures of the freeze-drying method shown as one example in FIG. 9.

First, the solution to be dried is stored in the tray 74 within the vacuum chamber 71 to conduct preliminary freezing (S21). That is, the freezer 73 is driven to bring the freezing pipe 76 within the cold trapping part 72 into a freezing mode.

Next, the vacuum pump 77 is driven to conduct vacuuming, thus the air within the vacuum chamber 71 and the cold trapping part 72 being removed (S22).

Thereafter, freeze-drying treatment is conducted (S23). That is, the solution on the tray 74 is sublimed within the vacuum chamber 71, with the latent heat of sublimation being supplied from the heater 75. The freezing pipe 76 cooled to a low temperature is disposed within the cold trapping part 72 where the pressure is kept at a level in balance with the vapor pressure within the vacuum chamber 71. In short, the evaporated solvent generated within the vacuum chamber 71 due to sublimation is cooled by the freezing pipe 76 to coagulate and adheres to the freezing pipe 76. Thus, drying of the solution proceeds while maintaining the inside of the vacuum chamber 71 in an approximately vacuum state. Also, since the heat removed from the solution on the tray 74 by sublimation and the heat supplied from the heater 75 offset each other, drying proceeds with scarce increase in the temperature of the solution on the tray 74. Further, the vacuum pump 77 is also utilized for discharging a non-condensed gas which is unable to be condensed in the drying step.

After completion of drying in the step S23, the vacuum state of the freeze-drying apparatus is released (S24).

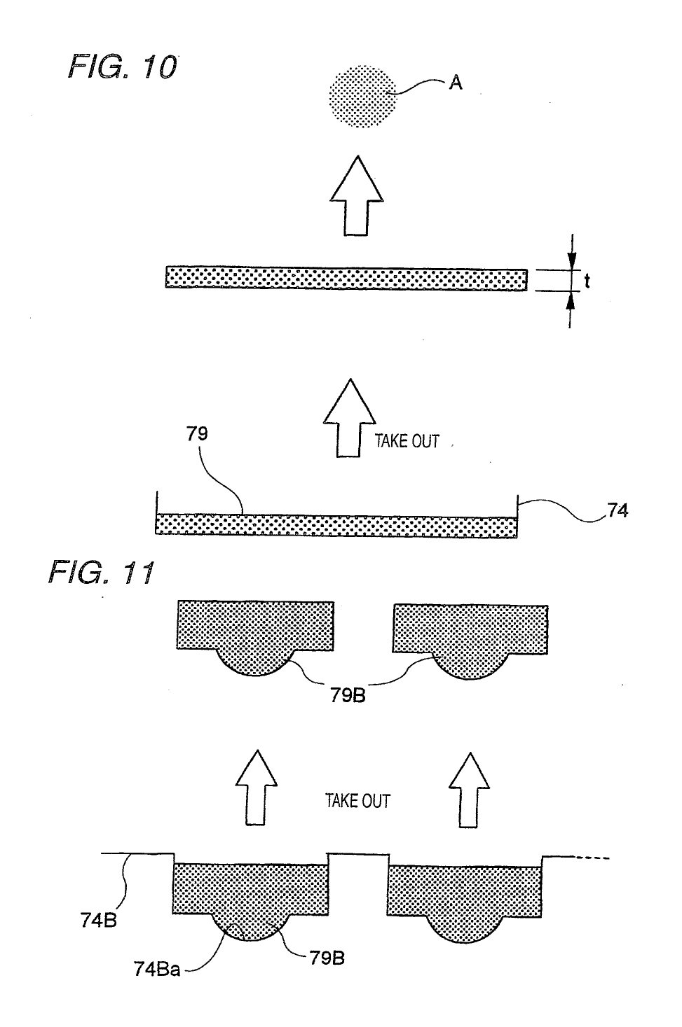

Then, as is shown in FIG. 10, the coagulated massive nanocomposite material 49 on the tray 74 is taken out of the vacuum chamber 41 (S25). The nanocomposite material is subjected, as needed, to a pulverizing treatment to pulverize the material into a finer powder body. Also, the massive nanocomposite material 49 may be cut into pieces each having a weight of one lens.

As is described above, in the case of freeze-drying the solution by using the freeze-drying apparatus 500 as shown in FIG. 8, the material can have an extremely high drying degree. Therefore, it is not necessary to conduct a further drying step corresponding to the vacuum-drying step S15 shown in FIG. 3. Also, the process of this embodiment scarcely generates static electricity in comparison with the spray drying method, and hence the resulting product is contaminated with a less amount of dust. In addition, since the surface area is larger than in the common natural drying (concentration drying), the drying speed is increased. Further, the material can be metered as a solution and can be dried as a mass, which serves to improve handling properties in the subsequent step.

In the case of conducting freeze-drying, however, the surface area of the entire solution upon initiation of drying is smaller than in the case of drying the solution in a state of being atomized into droplets as in the first embodiment, which prolongs the time necessary for drying corresponding to the reduction of the surface area. Therefore, in order to shorten the time necessary for drying by freeze-drying, it is of importance to enlarge the surface area of the solution upon drying treatment as much as possible.

That is, the drying treatment can be completed in a comparatively short time by conducting the freeze-drying with disposing the solution in a state of being thinly spread on the tray 74 having a large area as shown in, for example, FIGS. 8 and 10 to form a thin film of the nanocomposite material 79 having a small thickness of t. This thickness t is preferably 10 mm or less and, the smaller the thickness, the more accelerated is the drying treatment. In the case of conducting freeze-drying of the solution using this freeze-drying apparatus 500, the drying treatment can be completed in one step, thus the production steps being able to be simplified.

Also, prior to the drying treatment, the material may previously be concentrated by a concentration method, or by a technique such as pressure filtration or precipitation, e.g., reprecipitation, which serves to more shorten the drying time.

### Modified Example 1

In the above-described embodiment, it is assumed that the nanocomposite material taken out of the tray 74 after freeze-drying is pulverized to form a nanocomposite material which is used to mold an optical member. However, it is also possible to mold an optical member without pulverizing.

For example, as is shown in FIG. 11, in expectation of the final shape of a lens, a groove 74Ba having a shape approximate to the final shape after compression under pressure is formed in the surface of the tray 74B disposed within the freeze-drying apparatus, and the solution is poured into this groove 74B to conduct freeze-drying. Thus, a nanocomposite material 79B taken out of the tray 74B after freeze-drying is obtained as a preform having a larger thickness than that of the final shaped lens. This preform is heated and compression-molded in a mold which receives one preform to thereby obtain a final shape lens. This method permits metering in a solution state and not in a powder state, thus being excellent in productivity. Also, possibility of contamination with dust or the like is reduced, which makes it possible to manufacture optical members with higher quality.

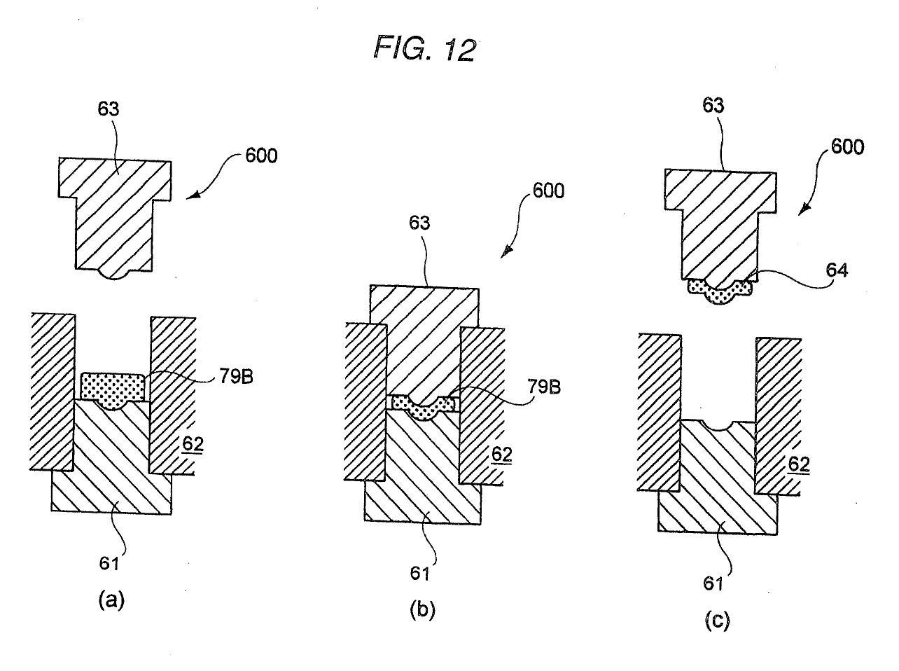

That is, as is shown in FIG. 12(a), the preform is introduced onto the lower metal mold 61 in the compression-molding apparatus 600 and, as is shown in FIG. 12(b), the preform is pressed between upper metal mold 63 and the lower metal mold 61 within the outer metal mold 62 under heating to thereby mold into the product shape. After cooling under pressing, the upper and lower metal molds 61 and 63 are released as shown in FIG. 12(c). Thus, voids existing in the preform are crushed, and a lens 64, which is an optical member molded into the final shape by compression molding, is taken out. Upon the heat-pressing, the atmosphere is preferably the vacuum atmosphere, the carbon dioxide gas atmosphere, or the nitrogen gas atmosphere as has been described hereinbefore. Thus, the nanocomposite material can be handled as a mass without pulverization, which serves to reduce handling works and produce an accurately shaped product.

Additionally, the groove 74 upon freeze-drying is made smaller than the external shape of the lens. Thus, the height of the preform becomes higher than that of the lens, which provides deformation allowance upon compression-molding in the latter stage.

### Modified Example 2

Next, other example of the freeze-drying method will be illustrated below.

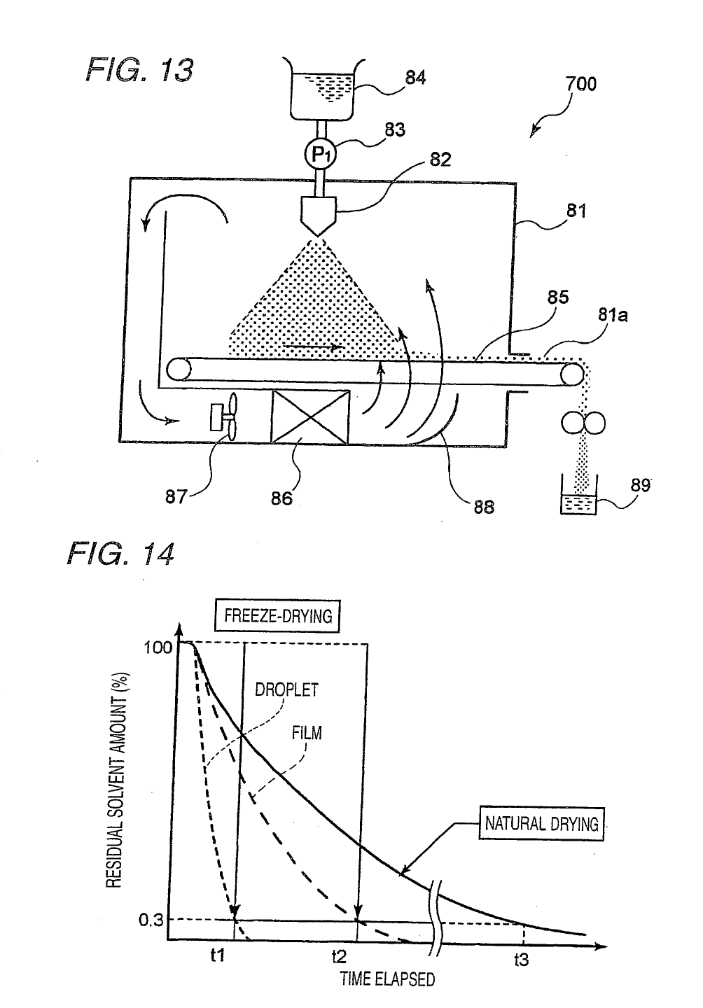

In the case of freeze-drying the solution by the freeze-drying method, drying the solution in a state of being atomized into droplets similar to the first embodiment serves to shorten the time required for drying. Therefore, for example, a spray type freezing apparatus as shown in FIG. 13 is utilized to form frozen powdery particles (not dried) from respective droplets. After treating the solution in the spray type freezing apparatus 700 shown in FIG. 13, the resulting frozen powdery particles are dry-treated in the freeze-drying apparatus 500 shown in FIG. 8, thus the time required for drying being able to be shortened.

The spray type freezing apparatus shown in FIG. 13 will be illustrated below. This spray type freezing apparatus 700 is equipped with a low-temperature chamber 81; a spray nozzle 82 disposed within the low-temperature chamber 81; a pump 83 for feeding a solution to the spray nozzle 82; a solution tank 84 connected to the pump 83; a mesh belt 85 disposed under the low-temperature chamber 81; a cooler 86 disposed under the mesh belt 85; a fan 87 which blows air toward the cooler 86 to generate a cooling air; and a guide plate 88 for circulating the cooling air to the low-temperature 81 through the mesh belt 85.

According to this spray type freezing apparatus 700, the solution to be dried stored in the solution tank 84 is sprayed downward as a mist of fine droplets through the spray nozzle 82 by driving the pump 83.

An air cooled by the cooler 86 is blown out by the fan 87 into the inside of the thermally insulated low-temperature chamber 81 into which the droplets of the solution is to be sprayed, and is circulated within the low-temperature chamber 81, thus the inside of the low-temperature chamber being cooled to a temperature at which freezing is possible.

The droplets of the solution sprayed through the spray nozzle 82 are cooled within the low-temperature chamber 81 and diffuse and deposit onto the mesh belt 85 with keeping the size of the droplet, and freezing proceeds gradually. The mesh belt 85 is driven in the direction shown by the arrow in FIG. 13, and the frozen particles formed from respective droplets are conveyed to the outlet 81a as the mesh belt 85 is driven. Then, the frozen particles are recovered by the vessel 89.

The powder body recovered in the vessel 89 contains a large amount of the solvent, and is subjected to the freeze-drying treatment using, for example, the freeze-drying apparatus 500 shown in FIG. 8. Such freeze-drying treatment permits freezing of the solution in a short time and, in addition, the drying treatment can be completed within a short time due to the large surface area of the frozen particles. As a result, the pulverizing step is not necessary, which serves to improve productivity and prevent contamination with dust.

The relation between the time elapsed and the residual amount of the solvent in the case of drying and solidifying the solution as described above is shown in FIG. 14.

For example, to define the residual amount of the solvent as the ratio of the solvent weight to the weight of the dissolved nanocomposite material, it has been understood that, in order to prepare a nanocomposite material capable of being utilized for molding an optical member, the solution must be dried till the residual amount of the solvent reaches 2% by weight or less. Additionally, the residual amount of the solvent upon initiation of drying amounts to as high as from 150% by weight to 600% by weight.

In the natural drying (concentration drying), the step of drying the solution unavoidably requires quite a long time (t3) as shown in FIG. 14. Therefore, it is of extreme importance to devise an improved drying step. In the case of conducting freeze-drying, the time required for drying (t1, t2) can be markedly shortened in comparison with the natural drying.

Here, the mechanism how the drying time is shortened will be described below.

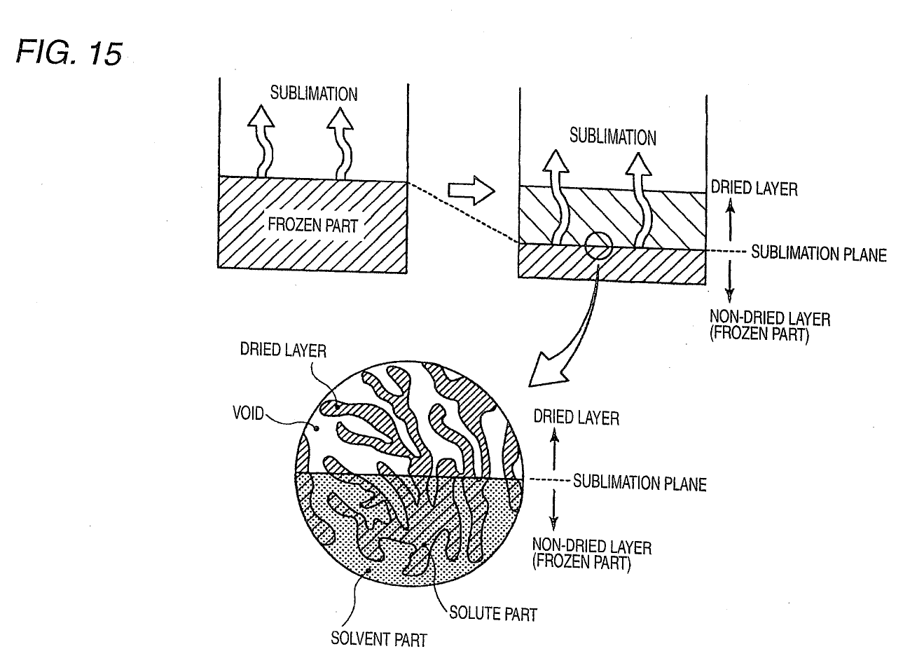

As is shown in FIG. 15, in freeze-drying, sublimation initiates from the upper surface of the frozen part, and the sublimation plane which is an interface between the dried layer and the non-dried layer (frozen part) gradually shifts downward into the frozen part with the progress of sublimation. In the vicinity of the sublimation plane, as is shown by the arrows in FIG. 15, the solvent portion in the dried layer disappears due to sublimation, with leaving only the solute, while both the solvent portion and the solute portion exist in the non-dried layer. Therefore, in the dried layer, the dried portion which has been a solute portion is formed with a high void ratio accompanying formation of vacancy. The solvent in the sublimation plane has a saturated value, and the sublimation place behaves to go down into the frozen part at a constant rate. In short, drying proceeds at a constant rate.

On the other hand, in the natural drying (concentration drying), the solvent vaporizes from the liquid surface, and it takes a long time for the molecules of the solvent in the solution to diffuse to the vaporization surface, and hence the solvent molecules difficultly appear from inside of the solution to the vaporization surface. Thus, the solvent concentration in the vicinity of the vaporization surface is decreased and, therefore, the drying rate is decreased. As a result, it takes quite a long time before completion of drying.

As has been described hereinbefore, freeze-drying shortens the drying time in comparison with natural drying. In particular, the time required for drying can be remarkably shortened by drying the solution in a state of a thin film or by drying the solution in a state of being atomized into separate droplets since the drying area of the solution is increased so much.

Next, the nanocomposite material (material wherein inorganic fine particles are contained in a thermoplastic resin) to be used for the process of the invention for producing an optical member will be described in detail below.

Although descriptions on the constituents to be given below are in some cases based on typical embodiments of the invention, the invention is not limited only to such embodiments.

Next, the nanocomposite material (material wherein inorganic fine particles are contained in a thermoplastic resin) to be used for the process of the invention for producing an optical member will be described in detail below.

Although descriptions on the constituents to be given below are in some cases based on typical embodiments of the invention, the invention is not limited only to such embodiments. Additionally, in this specification, a numeral range represented by “to” means that the numerical values described before and after “to” are included as the lower limit value and the higher limit value, respectively.

### (Compounds Represented by the Formula (1))

A nanocomposite material of the invention may contain a compound represented by the following formula (1) together with inorganic fine particles.

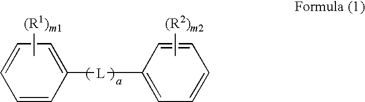

In the formula (1), R¹ and R² each independently represents a substituent. Substituents which R¹ and R² may have are not particularly limited, but are exemplified by a halogen atom (e.g., a fluorine atom, a chlorine atom, a bromine atom, or an iodine atom), an alkyl group (e.g., a methyl group or an ethyl group), an aryl group (e.g., a phenyl group or a naphthyl group), an alkenyl group, an alkynyl group, a cyano group, a carboxyl group, an alkoxycarbonyl group (e.g., a methoxycarbonyl group), an aryloxycarbonyl group (e.g., a phenoxycarbonyl group), a substituted or unsubstituted carbamoyl group (e.g., a carbamoyl group, an N-phenylcarbamoyl group, or an N,N-dimethylcarbamoyl group), an alkylcarbonyl group (e.g., an acetyl group), an arylcarbonyl group (e.g., a benzoyl group), a nitro group, an acylamino group (e.g., an acetamido group or an ethoxycarbonylamino group), a sulfonamido group (e.g., a methanesulfonamido group), an imido group (e.g., a succinimido group or a phthalimido group), an imino group (e.g., a benzylideneamino group), an alkoxy group (e.g., a methoxy group), an aryloxy group (e.g., a phenoxy group), an acyloxy group (e.g., an acetoxy group or a benzoyloxy group), an alkylsulfonyloxy group (e.g., a methanesulfonyloxy group), an arylsulfonyloxy group (e.g., a benzenesulfonyloxy group), a sulfo group, a substituted or unsubstituted sulfamoyl group (e.g., a sulfamoyl group or an N-phenylsulfamoyl group), an alkylthio group (e.g., a methylthio group), an arylthio group (e.g., a phenylthio group), an alkylsulfonyl group (e.g., a methanesulfonyl group), an arylsulfonyl group (e.g., a benzenesulfonyl group), a formyl group, and a heterocyclic group. These substituents may further be substituted. In the case where plural substituents exist within the molecule represented by the formula (1), the plural substituents may be the same or different from each other. Also, the substituent may form a condensed ring structure together with a benzene ring. The substituents of R¹ and R² are preferably a halogen atom, an alkyl group, an aryl group, a cyano group, an alkoxycarbonyl group, an aryloxycarbonyl group, a substituted or unsubstituted carbamoyl group, an alkylcarbonyl group, an arylcarbonyl group, a sulfonamido group, an alkoxy group, an aryloxy group, an acyloxy group, a substituted or unsubstituted sulfamoyl group, an alkylsulfonyl group, and an arylsulfonyl group; more preferably a halogen atom, an alkyl group, an aryl group, an alkoxy group, an aryloxy group, and an arylsulfonyl group; particularly preferably a halogen atom, an alkyl group, an aryl group, and an aryloxy group.

m1 and m2 each independently represents an integer of 0 to 5, preferably 0 to 3, more preferably 0 to 1. In the case where m1 and m2 each represents an integer of 2 or more, the substituents on the same benzene ring may be the same or different.

a represents 0 or 1. When a is 0, it means that the benzene rings are connected to each other through a single bond. When a is 1, the benzene rings are connected to each other through L. L represents an oxy group or a methylene group. Thus, the benzene rings in the compound represented by the formula (1) are connected to each other through a single bond, an oxy group, or a methylene group, with a single bond or an oxy group being preferred.

The molecular weight of the compound represented by the formula (1) is preferably less than 2,000, more preferably less than 1,000, still more preferably less than 700.

Specific examples of the compound represented by the formula (1) will be shown below. However, the compounds of the formula (1) capable of being used in the invention are not limited only to them.

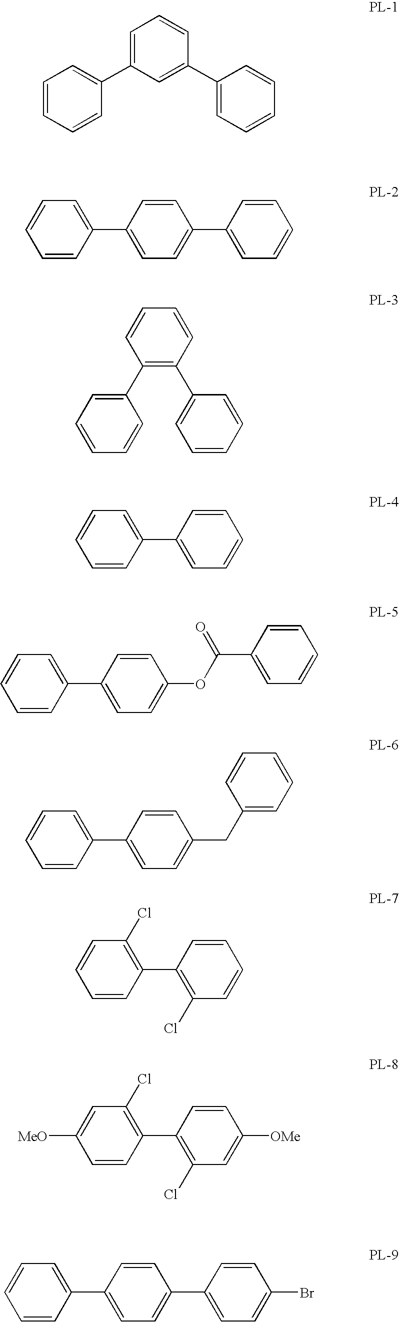

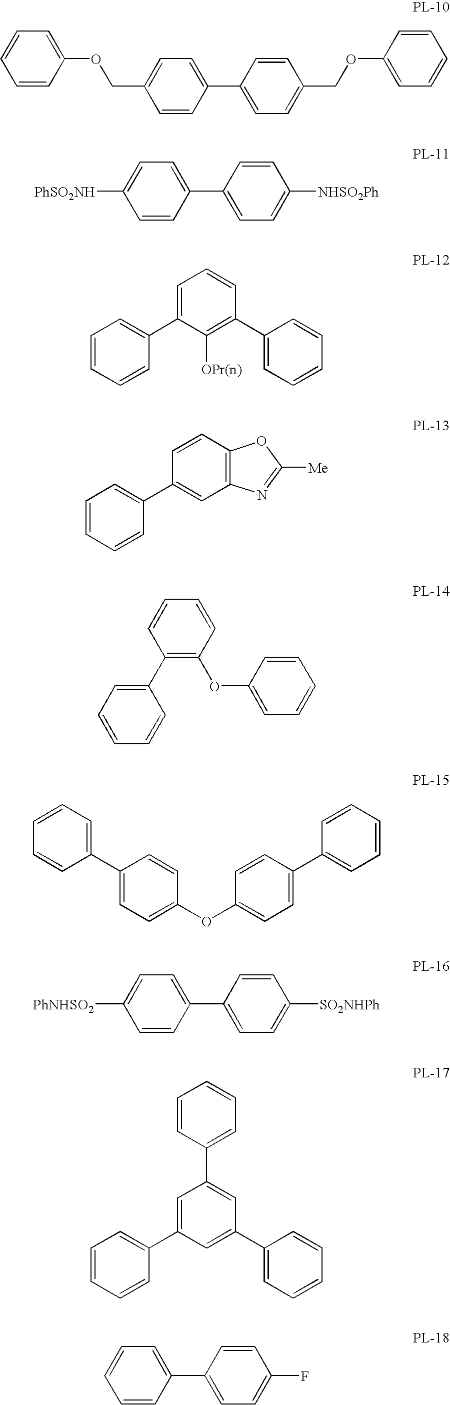

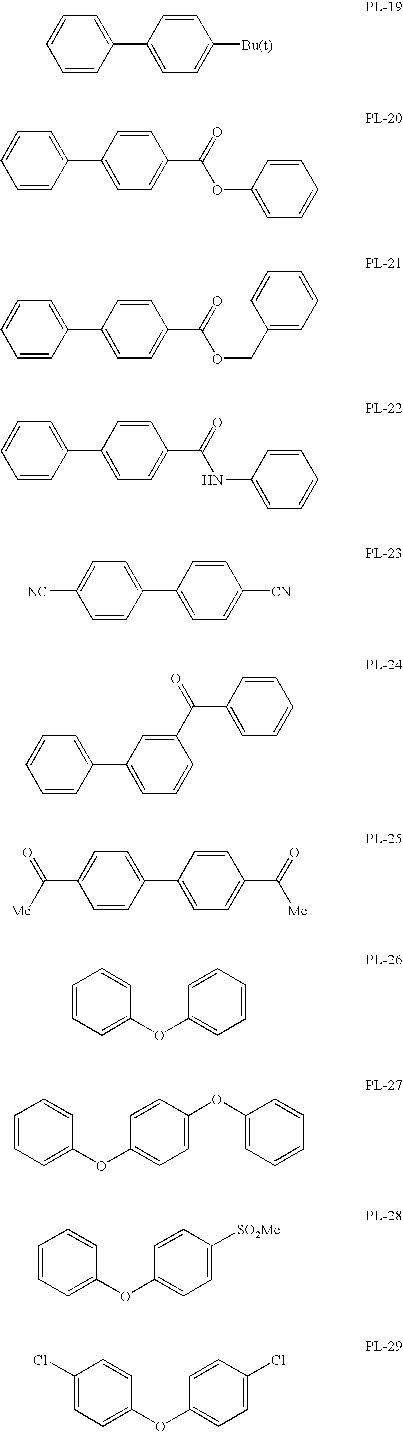

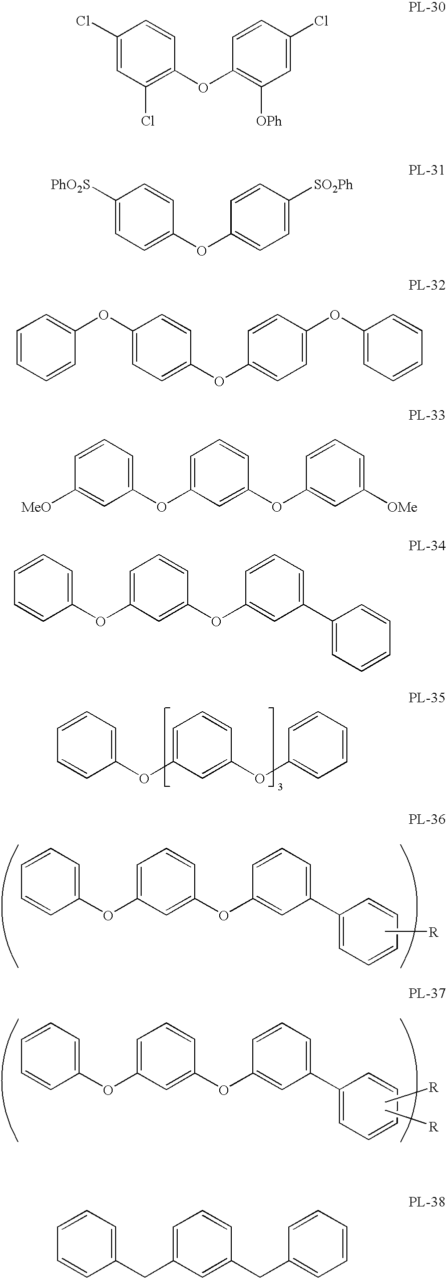

PL-34: S-3103; tetraphenylether type synthetic lubricating oil; manufactured by Matsumura Oil Research Corp.
PL-35: S-3105; pentaphenylether type synthetic lubricating oil; manufactured by Matsumura Oil Research Corp.
PL-36: S-31-1; monoalkyltetraphenylether type synthetic lubricating oil; manufactured by Matsumura Oil Research Corp.
PL-37: S-3230; dialkyltetraphenylether type synthetic lubricating oil; manufactured by Matsumura Oil Research Corp.

The compounds represented by the formula (1) may be synthesized according to processes well known to those skilled in the art, or may be available from the market. For example, S-3101, S-3103, S-3105, and S-3230 manufactured by Matsumura Oil Research Corp. may be used.

The addition amount of the compound represented by the formula (1) to the organic-inorganic composite composition is preferably from 0.1 to 30% by weight, more preferably from 0.3 to 25% by weight, still more preferably from 0.5 to 20% by weight. When the addition amount is 30% by weight or less, oozing during molding or during storage tends to be prevented whereas, when the addition amount is 0.1% by weight or more, the effects of the addition tend to be obtained. Additionally, the term “oozing” as used herein means the phenomenon that the added compound oozes out on the surface of the molding.

### (Inorganic Fine Particles)

A nanocomposite material of the invention may contain inorganic fine particles together with the compound represented by the formula (1). The inorganic fine particles to be used in the invention are not particularly limited and, for example, fine particles described in JP-A-2002-241612, JP-A-2005-298717, and JP-A-2006-70069 may be used.

Specifically, there may be used fine particles of an oxide (e.g., aluminum oxide, titanium oxide, niobium oxide, zirconium oxide, zinc oxide, magnesium oxide, tellurium oxide, yttrium oxide, indium oxide, or tin oxide), fine particles of a double oxide (e.g., lithium niobate, potassium niobate, or lithium tantalate), fine particles of a sulfide (e.g., zinc sulfide or cadmium sulfide), fine particles of semiconductor crystals (e.g., zinc selenide, cadmium selenide, zinc telluride, or cadmium telluride), and LiAlSiO₄, PbTiO₃, Sc₂W₃O₁₂, ZrW₂O₈, AlPO₄, Nb₂O₅, LiNO₃, etc.

Of these, fine particles of the metal oxides are preferred. In particular, any one selected from the group consisting of zirconium oxide, zinc oxide, tin oxide, and titanium oxide is preferred, any one selected from the group consisting of zirconium oxide, zinc oxide, and titanium oxide is more preferred and, further, use of fine particles of zirconium oxide which has good visible light-transmitting properties and low photo-catalytic activity is particularly preferred.

In view of refractive index, transparency, and stability, the inorganic fine particles to be used in the invention may be a composite comprising plural components. Also, in view of various purposes such as reduction of photo-catalytic activity and reduction of moisture absorbance, the inorganic fine particles may be doped with foreign elements, the surface layer thereof may be coated with other metal oxide such as silica or alumina, or the surface of the inorganic fine particles may be modified with a silane coupling agent, a titanate coupling agent, an aluminate coupling agent, or an organic acid (e.g., a carboxylic acid, a sulfonic acid, a phosphoric acid, or a phosphonic acid). Further, two or more of these may be combined to use according to the purpose.

The inorganic fine particles to be used in the invention are not particularly limited as to the refractive index but, in the case of using the nanocomposite material for an optical member which requires a high refractive index as in the invention, the inorganic fine particles preferably have high refractive index properties in addition to the above-described heat temperature dependence. In this case, the refractive index of the inorganic fine particles measured at 22° C. and at a wavelength of 589 nm is preferably from 1.9 to 3.0, more preferably from 2.0 to 2.7, particularly preferably from 2.1 to 2.5. When the refractive index of the inorganic fine particles is 3.0 or less, Rayleigh scattering tends to be suppressed with ease owing to a comparatively small difference in refractive index between the particles and the resin. Also, when the refractive index is 1.9 or more, the effects of the high refractive index tend to be easily obtained.

The refractive index of the inorganic fine particles can be estimated by a method of, for example, forming a transparent film from a composite thereof with a thermoplastic resin to be used in the invention, measuring the refractive index of the film with an Abbe's refractometer (e.g., “DM-M4” manufactured by ATAGO CO., LTD.), separately measuring the refractive index of the resin component alone, and calculating based on these two measured refractive indexes; or a method of measuring refractive indexes of dispersions containing the fine particles in different concentrations, and calculating the refractive index of the fine particles from the thus-measured refractive indexes.

Regarding the number-average particle size of the inorganic fine particles to be used in the invention, inorganic fine particles having a too small number-average particle size in some cases suffer change in characteristic properties intrinsic to the substances constituting the fine particles, whereas inorganic fine particles having a too large number-average particle size seriously suffer the influence of Rayleigh scattering and, in some cases, transparency of the organic-inorganic composite composition is extremely lowered. Therefore, the lower limit value of the number-average particle size of the inorganic fine particles to be used in the invention is preferably 1 nm or more, more preferably 2 nm or more, still more preferably 3 nm or more, whereas the higher limit value thereof is preferably 15 nm or less, more preferably 10 nm or less, still more preferably 7 nm or less.

That is, the number-average particle size of the inorganic fine particles in the invention is preferably from 1 nm to 15 nm, more preferably from 2 nm to 10 nm, particularly preferably from 3 nm to 7 nm.

Also, the inorganic fine particles to be used in the invention preferably satisfy the above-described requirement for the average particle size and, in addition, have a narrower particle size distribution. Mono-disperse particles are defined in various manners but, as to the preferred particle size distribution range of the fine particles to be used in the invention, the numerical ranges described in, for example, JP-A-2006-160992 applies.

Here, the number-average particle size can be measured by means of, for example, an X-ray diffraction (XRD) apparatus or a transmission type electron microscope (TEM).

The inorganic fine particles to be used in the invention are not particularly limited as to the process for their production, and any known process may be employed.

For example, desired oxide fine particles can be obtained by using a metal halide or a metal alkoxide as a starting material and hydrolyzing in a water-containing reaction system. Detailed descriptions on this process are given in, for example, Japanese Journal of Applied Physics, vol. 37, pp. 4603-4608 (1998); or Langmuir, vol. 16, No. 1, pp 241-246 (2000).

As other process than the process of hydrolyzing in water, there may be employed a process of preparing inorganic fine particles in an organic solvent or in an organic solvent wherein the thermoplastic resin in the invention is dissolved. In this process, various surface treating agents (e.g., silane coupling agents, aluminate coupling agents, titanate coupling agents, and organic acids (e.g., carboxylic acids, sulfonic acids, and phosphonic acids)) may be allowed to co-exist.

Examples of the solvent to be used in these processes include acetone, 2-butanone, dichloromethane, chloroform, toluene, ethyl acetate, cyclohexane, and anisole. These may be used independently or a plurality of them may be mixed to use.

As processes for synthesizing the inorganic fine particles, there are illustrated, beside the above-described processes, various general processes for synthesizing fine particles such as processes of preparing in a vacuum state, for example, a molecular beam epitaxy process and a CVD process described in, for example, JP-A-2006-70069.

In view of transparency and obtaining high refractive index, the content of the inorganic fine particles in the nanocomposite material of the invention is preferably from 20 to 95% by weight, more preferably from 25 to 70% by weight, particularly preferably from 30 to 60% by weight. Also, in view of dispersibility, the weight ratio of the inorganic fine particles to the thermoplastic resin (dispersed polymer) in the invention is preferably from 1:0.01 to 1:100, more preferably from 1:0.05 to 1:10, particularly preferably from 1:0.05 to 1:5.

### (Thermoplastic Resin)

A nanocomposite material of the invention contains a thermoplastic resin. In particular, the nanocomposite material of the invention preferably contains a thermoplastic resin which has, at the end of the polymer chain or in the side chain, functional groups capable of forming an arbitrary chemical bond with the inorganic fine particles. The term “chemical bond” as used herein is defined to include a covalent bond, an ion bond, a hydrogen bond, and a coordination bond. As preferred examples of such thermoplastic resin, the following 3 kinds of thermoplastic resins can be illustrated:

(1) thermoplastic resins having in the side chain thereof a functional group selected from the following:

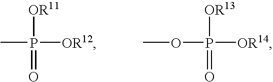

(wherein, R¹¹, R¹², R¹³, and R¹⁴ each independently represents a hydrogen atom, a substituted or unsubstituted alkyl group, a substituted or unsubstituted alkenyl group, a substituted or unsubstituted alkynyl group, or a substituted or unsubstituted aryl group), —SO₃H, —OSO₃H, —CO₂H, or —Si(OR¹⁵)ₘ₁R¹⁶₃₋ₘ₁ (wherein R¹⁵ and R¹⁶ each independently represents a hydrogen atom, a substituted or unsubstituted alkyl group, a substituted or unsubstituted alkenyl group, a substituted or unsubstituted alkynyl group, or a substituted or unsubstituted aryl group, and m¹ represents an integer of 1 to 3);
(2) thermoplastic resins having in at least one end of the polymer a functional group selected from the following:

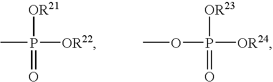

(wherein, R²¹, R²², R²³, and R²⁴ each independently represents a hydrogen atom, a substituted or unsubstituted alkyl group, a substituted or unsubstituted alkenyl group, a substituted or unsubstituted alkynyl group, or a substituted or unsubstituted aryl group), —SO₃H, —OSO₃H, —CO₂H, or —Si(OR²⁵)ₘ₂R²⁶₃₋ₘ₂ (wherein R²⁵ and R²⁶ each independently represents a hydrogen atom, a substituted or unsubstituted alkyl group, a substituted or unsubstituted alkenyl group, a substituted or unsubstituted alkynyl group, or a substituted or unsubstituted aryl group, and m2 represents an integer of 1 to 3); and
(3) block copolymers constituted by a hydrophobic segment and a hydrophilic segment.

The thermoplastic resins (3) will be particularly described in detail below.

### <Thermoplastic Resins (3)>

The thermoplastic resin (3) to be used in the invention is a block copolymer constituted by a hydrophobic segment and a hydrophilic segment.

Here, the hydrophobic segment (A) means such a segment that a polymer comprising the segment (A) alone has the characteristic properties of not being soluble in water or methanol, and the hydrophilic segment (B) means such a segment that a polymer comprising the segment (B) alone has the characteristic properties of being soluble in water or methanol. As types of the block copolymers, there are illustrated an AB type, B¹AB² type (wherein two hydrophilic segments of B¹ and B² may be the same or different), and A¹BA² type (wherein two hydrophobic segments of A¹ and A² may be the same or different). In view of good dispersibility, an AB type or A¹BA² type block copolymer is preferred and, in view of production adaptability, an AB type or ABA type (wherein the two hydrophobic segments of A¹BA² type are the same) is more preferred, with an AB type being particularly preferred.

The hydrophobic segment and the hydrophilic segment can be respectively selected from any conventionally known polymers such as vinyl polymers obtained by polymerization of a vinyl monomer, polyethers, ring-opening metathesis polymerization polymers, and condensation polymers (e.g., polycarbonates, polyesters, polyamides, polyether ketones, and polyether sulfones). Of these, vinyl polymers, ring-opening metathesis polymerization polymers, polycarbonates, and polyesters are preferred and, in view of production adaptability, vinyl polymers are more preferred.

As the vinyl monomer (A) for forming the hydrophobic segment (A), there are illustrated, for example, the following:

acrylic esters and methacrylic esters (wherein the ester group is a substituted or unsubstituted aliphatic ester group, or a substituted or unsubstituted aromatic ester group, such as a methyl group, a phenyl group, or a naphthyl group);

acrylamides and methacrylamides, specifically N-monosubstituted acrylamides, N-disubstituted acrylamides, N-monosubstituted methacrylamides, and N-disubstituted methacrylamides (wherein the substituent of the monosubstituted and disubstituted amides is a substituted or unsubstituted aliphatic group, or a substituted or unsubstituted aromatic group, such as a methyl group, a phenyl group, or a naphthyl group);

olefins, specifically, dicyclopentadiene, norbornene derivatives, ethylene, propylene, 1-butene, 1-pentene, vinyl chloride, vinylidene chloride, iroprene, chloroprene, butadiene, 2,3-dimethylbutadiene, vinylarbazole, etc.; styrenes, specifically, styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, tribromostyrene, methyl vinylbenzoate, etc.;

vinyl ethers, specifically, methyl vinyl ether, butyl vinyl ether, phenyl vinyl ether, methoxyethyl vinyl ether, etc.; and other monomers such as butyl crotonate, hexyl crotonate, dimethyl itaconate, dibutyl itaconate, diethyl maleate, dimethyl maleate, dibutyl maleate, diethyl fumarate, dimethyl fumarate, dibutyl fumarate, methyl vinyl ketone, phenyl vinyl ketone, methoxyethyl vinyl ketone, N-vinyloxazolidone, N-vinylpyrrolidone, vinylidene chloride, methylenemalononitrile, vinylidene, diphenyl-2-acryloyloxyehyl phosphate, diphenyl-2-methacryloyloxyethyl phosphate, dibutyl-2-acryloyloxyethyl phosphate, dioctyl-2-methacryloyloxyethyl phosphate, etc.

Of these, acrylic esters and methacrylic esters wherein the ester group is a substituted or unsubstituted aliphatic group, or a substituted or unsubstituted aromatic group; N-monosubstituted acrylamides, N-disubstituted acrylamides, N-monosubstituted methacrylamides, and N-disubstituted methacrylamides wherein the substituent is a substituted or unsubstituted aliphatic group, or a substituted or unsubstituted aromatic group; and styrenes are preferred, and acrylic esters and methacrylic esters wherein the ester group is a substituted or unsubstituted aliphatic group, or a substituted or unsubstituted aromatic group; and styrenes are more preferred.

As the vinyl monomer (B) for forming the hydrophilic segment (B), there are illustrated, for example, the following:

acrylic acid, methacrylic acid, acrylic esters and methacrylic esters each having a hydrophilic substituent in the ester moiety; styrenes each having a hydrophilic substituent in the aromatic ring moiety; vinyl ethers, acrylamides, methacrylamides, N-monosubstituted acrylamides, N-disubstituted acrylamides, N-monosubstituted methacrylamides, and N-disubstituted methacrylamides each having a hydrophilic substituent.

As the hydrophilic substituent, those substituents are preferred which have a functional group selected from the group consisting of:

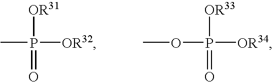

(wherein, R³¹, R³², R³³, and R³⁴ each independently represents a hydrogen atom, a substituted or unsubstituted alkyl group, a substituted or unsubstituted alkenyl group, a substituted or unsubstituted alkynyl group, or a substituted or unsubstituted aryl group), —SO₃H, —OSO₃H, —CO₂H, —OH, and —Si(OR³⁵)ₘ₃R³⁶₃₋ₘ₃ (wherein R³⁵ and R³⁶ each independently represents a hydrogen atom, a substituted or unsubstituted alkyl group, a substituted or unsubstituted alkenyl group, a substituted or unsubstituted alkynyl group, or a substituted or unsubstituted aryl group, and m3 represents an integer of 1 to 3).

When R³¹, R³², R³³, R³⁴, R³⁵, and R³⁶ each represents a substituted or unsubstituted alkyl group, a substituted or unsubstituted alkenyl group, a substituted or unsubstituted alkynyl group, or a substituted or unsubstituted aryl group, preferred scopes thereof are the same as those which have been described as preferred scopes of R¹¹, R¹², R¹³, and R¹⁴. Also, m3 is preferably 3.

As the functional group,

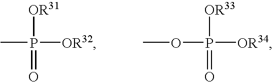

—CO₂H, and —Si(OR³⁵)ₘ₃R³⁶₃₋ₘ₃ are preferred,

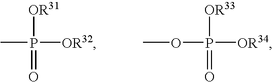

and —CO₂H are more preferred,

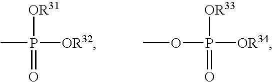

are particularly preferred.

In the invention, the block copolymer particularly preferably has a functional group selected from

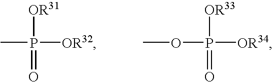

—SO₃H, —OSO₃H, —CO₂H, —OH, and —Si(OR³⁵)ₘ₃R³⁶₃₋ₘ₃, with the content of the functional group being from 0.05 mmol/g to 5.0 mmol/g.

In particular, as the hydrophilic segment (B), acrylic acid, methacrylic acid, an acrylic ester and methacrylic ester having a hydrophilic substituent in the ester moiety, and a styrene having a hydrophilic substituent in the aromatic ring moiety are preferred.

The vinyl monomer (A) forming the hydrophobic segment (A) may include the vinyl monomer (B) within the range of not inhibiting hydrophobic properties. The molar ratio of the vinyl monomer (A) to the vinyl monomer (B) contained in the hydrophobic segment (A) is preferably from 100:0 to 60:40.

The vinyl monomer (B) forming the hydrophilic segment (B) may include the vinyl monomer (A) within the range of not inhibiting hydrophilic properties. The molar ratio of the vinyl monomer (B) to the vinyl monomer (A) contained in the hydrophobic segment (B) is preferably from 100:0 to 60:40.

With each of the vinyl monomers (A) and (B), one member may be used independently, or two or more thereof may be used in combination thereof. The vinyl monomer (A) and the vinyl monomer (B) are selected according to various purposes (e.g., adjustment of the acid content and the glass transition point (Tg), adjustment of solubility for an organic solvent or water, and adjustment of stability of the dispersion).

The content of the functional group based on the entire block copolymer is preferably from 0.05 to 5.0 mmol/g, more preferably from 0.1 to 4.5 mmol/g, particularly preferably from 0.15 to 3.5 mmol/g. When the content of the functional group is too small, there might result a small dispersion adaptability whereas, when too large, there might result a too high solubility for water and gelation of the organic-inorganic composite composition. Additionally, in the block copolymer, the functional group may form a salt with an alkali metal ion (e.g., Na⁺ or K⁺) or with a cationic ion such as ammonium ion.

The molecular weight (Mn) of the block copolymer is preferably from 1,000 to 100,000, more preferably from 2,000 to 80,000, particularly preferably from 3,000 to 50,000. The block copolymer having a molecular weight of 1,000 or more tends to provide a stable dispersion, and the block copolymer having a molecular weight of 100,00 or less tends to have an improved solubility for an organic solvent, thus being preferred.

The block copolymer to be used in the invention has a refractive index of preferably more than 1.50, more preferably more than 1.55, still more preferably more than 1.60, particularly preferably more than 1.65. Additionally, the refractive index as used herein is a value measured by an Abbe's refractometer (“DM-M4” manufactured by ATAGO CO., LTD.) using a light of 589 nm in wavelength.

The block copolymer to be used in the invention has a glass transition temperature of preferably from 80° C. to 400° C., more preferably from 130° C. to 380° C. The block copolymer having a glass transition temperature of 80° C. or more tends to have an improve heat resistance, and the block copolymer having a glass transition temperature of 400° C. or less tends to have an improved molding processability.

The light transmittance of the block copolymer to be used in the invention, in terms of 1 mm thickness, with respect to light of 589 nm in wavelength is preferably 80% or more, more preferably 85% or more.

Specific examples of the block copolymer (illustrative compounds Q-1 to Q-20) will be illustrated below. Additionally, the block copolymers to be used in the invention are not limited to only to them.

TABLE 1

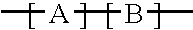

| | | | | | Molecular |
|---|---|---|---|---|---|
| No. | —A— | Mol % | —B— | Mol % | Weight |
| Q-1 | 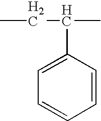 | 90 | 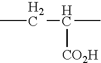 | 10 | 31000 |
| Q-2 | 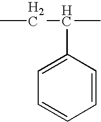 | 95 | 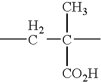 | 5 | 28000 |
| Q-3 | 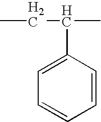 | 80 | 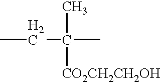 | 20 | 25000 |
| Q-4 | 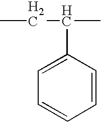 | 90 | 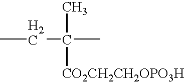 | 10 | 30000 |
| Q-5 | 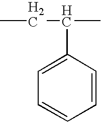 | 85 | 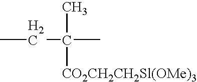 | 15 | 22000 |
| Q-6 | 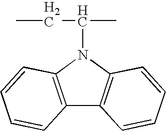 | 88 | 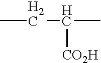 | 12 | 26000 |
| Q-7 | 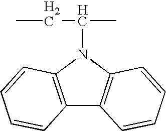 | 92 | 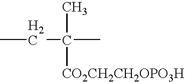 | 8 | 30000 |
| Q-8 | 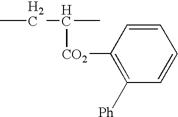 | 90 | 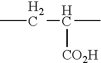 | 10 | 33000 |
| Q-9 | 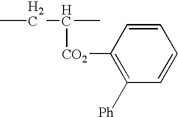 | 93 | 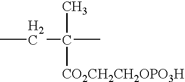 | 7 | 34000 |
| Q-10 | 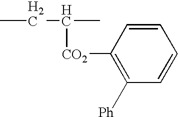 | 80 | 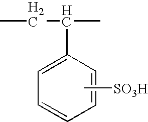 | 20 | 24000 |
| Q-11 | 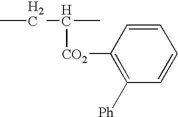 | 90 | 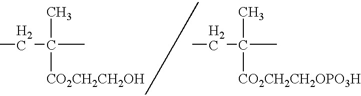 | 10 | 27000 |
| Q-12 | 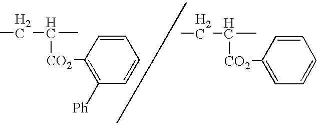 | 95 | 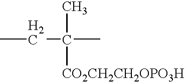 | 5 | 30000 |

TABLE 2

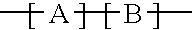

| | | | | | Molecular |
|---|---|---|---|---|---|
| No. | —A— | Mol % | —B— | Mol % | Weight |
| Q-13 | 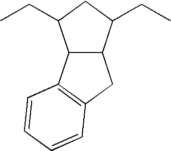 | 90 | 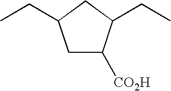 | 10 | 35000 |
| Q-14 | 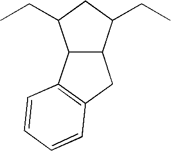 | 95 | 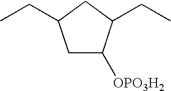 | 5 | 30000 |
| Q-15 | 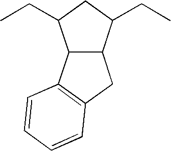 | 80 | 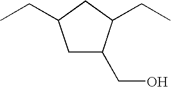 | 20 | 31000 |
| Q-16 | 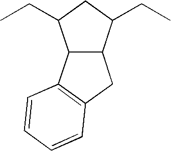 | 95 | 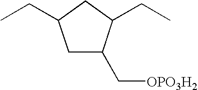 | 5 | 29000 |
| Q-17 | 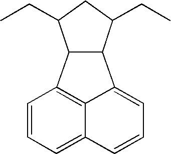 | 88 | 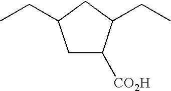 | 12 | 33000 |
| Q-18 | 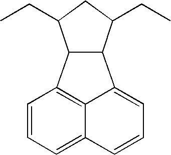 | 90 | 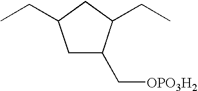 | 10 | 28000 |
| Q-19 | 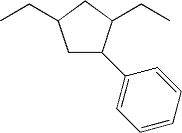 | 85 | 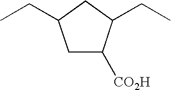 | 15 | 35000 |
| Q-20 | 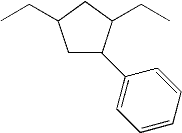 | 93 | 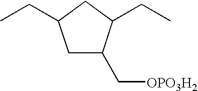 | 7 | 36000 |

The block copolymers can be synthesized by utilizing living radical polymerization or living ion polymerization with employing, as needed, the technique of protecting a carboxyl group or of introducing a functional group. The block copolymers can also be synthesized by radical polymerization from a polymer having a terminal functional group or by linking polymers each having a terminal functional group to each other. In view of controlling molecular weight and yield of the block copolymer, living radical polymerization and living ion polymerization are preferably utilized. As to the processes for producing the block copolymers, descriptions are given in, for example, Methods for preparing block copolymers are disclosed in, for example, Kobunshi no Gosei to Hanno (1) (Synthesis and Reactions of Polymers (1)) (edited by Kobunshi Gakkai (the Polymer Society), published by Kyoritsu Shuppan Co., Ltd. (1992)), Seimitsu Jyugo (Precise Polymerization) (edited by Nihon Kagakkai (the Japan Chemical Society), published by Gakkai Shuppan Center (1993)), Kobunshi no Gosei/Hanno (1) (Synthesis/Reactions of Polymers (1)) (edited by Kobunshi Gakkai (the Polymer Society), published by Kyoritsu Shuppan Co., Ltd. (1995)), Telechelic Polymers: Synthesis and Properties, and Application (R. Jerome et al., Prog. Polym. Sci., Vol. 16, pp. 837 906 (1991)), Synthesis of Block and Graft Copolymers by Light (Y. Yagch et al., Prog. Polym. Sci., Vol. 15, pp. 551-601 (1990)), U.S. Pat. No. 5,085,698, and the like.

These resins may be used independently or as a mixture of two or more of them.

### (Other Additives)

In addition to the above-described compound represented by the foregoing formula (1), the inorganic fine powders, and the thermoplastic resin, various additives may properly be incorporated in the nanocomposite material of the invention in view of uniform dispersibility, releasing properties, and weatherability. For example, there can be illustrated a surface treating agent, an antistatic agent, a dispersing agent, a plasticizer, and a releasing agent. Also, other resins not having the functional group may be added in addition to the aforesaid resins. Such resins are not particularly limited as to kind, but those resins are preferred which have about the same optical properties, thermal properties, and molecular weight as those of the aforesaid thermoplastic resins.

The compounding amounts of these additives vary depending upon the purpose, but are preferably from 0 to 50% by weight, more preferably from 0 to 30% by weight, particularly preferably from 0 to 20% by weight, based on the total weight of the inorganic fine particles and the thermoplastic resin.

### <Surface Treating Agent>

In the invention, a surface treating agent for the fine particles other than the above-described thermoplastic resin may be added, upon mixing the inorganic fine particles dispersed in water or in an alcohol solvent with the thermoplastic resin as will be described hereinafter, according to various purposes such as a purpose of enhancing extraction properties into an organic solvent or substitution properties, a purpose of enhancing uniform dispersibility in the thermoplastic resin, a purpose of reducing moisture absorbance of the fine particles, and a purpose of enhancing weatherability. The weight-average molecular weight of such surface treating agent is preferably from 50 to 50,000, more preferably from 100 to 20,000, still more preferably from 200 to 10,000.

As the surface treating agent, those which have a structure represented by the following formula (2) are preferred:

### Formula (2): A-B

In the above formula (2), A represents a functional group capable of forming a chemical bond with the surface of the inorganic fine particles to be used in the invention, and B represents a monovalent group or polymer containing from 1 to 30 carbon atoms and having compatibility or reactivity with the resin matrix which constitutes the major component of the thermoplastic resin to be used in the invention. The term “chemical bond” as used herein means, for example, a covalent bond, an ion bond, a coordination bond, and a hydrogen bond.

Preferred examples of the group represented by A are the same as those referred to as the functional groups for the thermoplastic resins to be used in the invention.

On the other hand, in view of compatibility, the chemical structure of the group represented by B is preferably the same as, or analogous to, the chemical structure of the thermoplastic resin which is a major component of the resin matrix. In the invention, both the chemical structure of B and the thermoplastic resin preferably have an aromatic ring in view of enhancement of refractive index.

Examples of the surface treating agent to be preferably used in the invention include p-octylbenzoic acid, p-propylbenzoic acid, acetic acid, propionic acid, cyclopentanecarboxylic acid, dibenzyl phosphate, monobenzyl phosphate, diphenyl phosphate, di-α-naphthyl phosphate, phenylphosphonic acid, monophenyl phenylphosphonate, KAYAMER PM-21 (trade name; manufactured by Nippon Kayaku), benzenesulfonic acid, naphthalenesulfonic acid, p-octylbenzenesulfonic acid, and silane coupling agents described in JP-A-5-221640, JP-A-9-100111, and JP-A-2002-187921. However, these are not limitative at all.

These surface treating agents may be used independently or in combination of two or more thereof.

The total addition amount of these surface treating agents is preferably from a 0.01- to 2-fold amount by weight based on the amount of the inorganic fine particles, more preferably from a 0.03- to 1-fold amount, particularly preferably from 0.05 to 0.5-fold amount.

### <Antistatic Agents>

In order to adjust the static electrification voltage of the nanocomposite material of the invention, an antistatic agent may be added thereto. In the nanocomposite material of the invention, the inorganic fine particles themselves which are added for the purpose of improving optical characteristic properties in some cases contribute to the different effect of antistatic effect. In the case of adding the antistatic agent, examples thereof include anionic antistatic agents, cationic antistatic agents, nonionic antistatic agents, amphoteric antistatic agents, high-molecular antistatic agents, and antistatic fine particles. These may be used in combination of two or more thereof. As examples thereof, there can be illustrated compounds described in JP-A-2007-4131 and JP-A-2003-201396.

The addition amount of the antistatic agent varies, but is preferably from 0.001 to 50% by weight, more preferably from 0.01 to 30% by weight, particularly preferably from 0.1 to 10% by weight, based on the weight of all of the solid components.

### <Others>

Beside the above-described compounds, natural waxes such as plant waxes (e.g., carnauba wax, rice wax, cotton wax and wood wax), animal waxes (e.g., beeswax and lanolin), mineral waxes (e.g., ozocerite and ceresine), and petroleum waxes (e.g., paraffin, microcrystalline, and petrolatum); synthetic hydrocarbon waxes such as Fischer-Tropsch wax and polyethylene wax; synthetic waxes such as long-chain aliphatic amide, ester, ketone and ether (e.g., strearic acid amide and chlorinated hydrocarbon); silicone oils such as dimethylsilicone oil and methylphenylsilicone oil; and fluorine-containing teromers such as Zonyl FSN and Zonyl FSO manufactured by du Pont may be added in order to enhance the releasing effect and more improve fluidity upon molding. Further, for the purpose of improving light resistance and heat resistance, there may properly be added known deterioration-preventing agents such as hindered phenols, amines, phosphorus-containing compounds, and thioethers. In the case of incorporating these compounds, they are incorporated in an amount of preferably from about 0.1 to 5% by weight based on the weight of the total solid components of the resin composition.

### (Method for Producing the Organic-Inorganic Composite Composition)

The nanocomposite material of the invention can be produced preferably by dispersing the inorganic fine particles in the resin having the aforesaid functional group while forming a chemical bond with the resin. In this occasion, the compound represented by the formula (1) is allowed to exist.

The inorganic fine particles to be used in the invention has a small particle size and a high surface energy and, once isolated as a solid body, its re-dispersion is difficult. Therefore, it is preferred to mix the inorganic fine particles in a state of being dispersed in a solution with the thermoplastic resin to obtain a stable dispersion. As a preferred method for producing the nanocomposite material, there are illustrated

(1) a process of surface-treating the inorganic fine particles in the presence of the above-mentioned surface-treating agent, extracting the surface-treated inorganic fine particles into an organic solvent, and uniformly mixing the thus-extracted inorganic fine particles with the thermoplastic resin and the compound represented by the formula (1) to thereby produce a composite of the inorganic fine particles and the thermoplastic resin; and
(2) a process of uniformly mixing all components by using a solvent capable of uniformly dispersing or dissolving the inorganic fine particles, the thermoplastic resin, the compound represented by the formula (1), and other additives to thereby produce a composite of the inorganic fine particles and the thermoplastic resin.

In the case of producing the composite of the inorganic fine particles and the thermoplastic resin according to the process (1) described above, water-insoluble solvents such as toluene, ethyl acetate, methyl isobutyl ketone, chloroform, dichloromethane, dichloroethane, chlorobenzene, and methoxybenzene are used as the organic solvent. The surface treating agent to be used for extracting the fine particles into the organic solvent and the thermoplastic resin may be the same or different. As surface treating agents to be preferably used, there are illustrated those which have been referred to in the paragraph of <Surface treating agents>.

Upon mixing the inorganic fine particles having been extracted into the organic solvent with the thermoplastic resin, the compound represented by the foregoing formula (1) may also be added and, further, a plasticizer, a releasing agent, or other kind of polymer may be added as needed.

In the case of employing the process (2) described above, there is used as a solvent a single or mixed solvent of hydrophilic polar solvents such as dimethylacetamide, dimethylformamide, dimethylsulfoxide, benzyl alcohol, cyclohexanol, ethylene glycol monomethyl ether, 1-methoxy-2-propanol, tert-butanol, acetic acid, and propionic acid; or a mixed solvent between a water-insoluble solvent such as chloroform, dichloroethane, dichloromethane, ethyl acetate, methyl ethyl ketone, methyl isobutyl ketone, toluene, chlorobenzene, or methoxybenzene and the above-described polar solvent. In this occasion, a dispersing agent, a plasticizer, a releasing agent or other king of polymer may be added, as needed, in addition to the aforesaid thermoplastic resin. In the case of using fine particles dispersed in water/methanol, it is preferred to add a hydrophilic solvent having a higher boiling point than water/methanol and capable of dissolving the thermoplastic resin, distilling off water/methanol to concentrate and replace the dispersing solution of the fine particles by the polar organic solvent, and then mixing it with the resin. In this occasion, the surface treating agent may be added.

### EXAMPLES

The invention will be more specifically described below by reference to Examples. Materials, used amounts, ratios, treating contents, treating procedures, and the like can properly be changed unless departing from the gist of the invention. Therefore, the scope of the invention should not be construed to be limited by the following specific examples.

A dry nanocomposite material is prepared according to the following process to measure the amount of residual solvent and the specific surface area.

### (Preparation of Dispersion of Fine Particles)

### (1) Synthesis of Fine Particles of Zirconium Oxide

A 50 g/L zirconium oxychloride solution is neutralized with a 48% sodium hydroxide aqueous solution to obtain a hydrated zirconium suspension. This suspension is filtered and washed with deionized water to obtain a cake of hydrated zirconium. This cake is adjusted to a concentration of 15% by weight in terms of zirconium oxide using deionized water as a solvent, and is placed in an autoclave, followed by hydrothermal treatment at a pressure of 150 atmosphere and 150° C. for 24 hours to obtain a suspension of fine particles of zirconium oxide. Formation of fine particles of zirconium oxide having a number-average particle size of 5 nm is confirmed by TEM. The refractive index of the fine particles is found to be 2.1.

### (2) Preparation of a Dispersion of Zirconium Oxide in Dimethylacetamide

500 g of N,N′-dimethylacetamide is added to 500 g of the suspension of zirconium oxide prepared in (1) (concentration: 15% by weight) and, after concentrating under reduced pressure to about 500 g or less to conduct solvent substitution, the concentration is adjusted by adding N,N′-dimethylacetamide to thereby obtain a 15% by weight dispersion of zirconium oxide in dimethylacetamide.

### (Synthesis of Thermoplastic Resin)

### Synthesis of a Thermoplastic Resin Q-1

A mixed solution comprising 2.1 g of tert-butyl acrylate, 0.72 g of tert-butyl 2-bromopropionate, 0.46 g of copper (I) bromide, 0.56 of N,N,N′,N′,N″,N″-pentamethyldiethylenetriamine, and 9 ml of methyl ethyl ketone is prepared, and the atmosphere is replaced by nitrogen. The mixed solution is stirred for one hour at an oil bath temperature of 80° C., followed by adding 136.2 g of styrene is added thereto under a stream of nitrogen. The mixture is stirred for 16 hours at an oil bath temperature of 90° C. and, after the temperature is decreased to room temperature, 100 ml of ethyl acetate and 30 g of alumina are added thereto, followed by stirring the resulting mixture for 30 minutes. This reaction solution is filtered, and the filtrate is dropwise added to excess methanol. The precipitate thus-formed is collected by filtration, washed with methanol, and dried to obtain 61 g of the resin. This resin is dissolved in 300 ml of toluene, and 6 g of p-toluenesulfonic acid monohydrate is added thereto, followed by refluxing for 3 hours under heating. This reaction solution is dropwise added to excess methanol. The precipitate thus-formed is collected by filtration, washed with methanol, and dried to obtain 55 g of a block copolymer Q-1 shown in Table 1. The number-average molecular weight and the weight-average molecular weight of the resin measured by GPC are 32,000 and 35,000, respectively. Also, the refractive index of the resin measured by the Abbe's refractometer is 1.59.

### (Preparation of Solution of the Nanocomposite Material)

The thermoplastic resin Q-1, compound PL-1, and a surface treating agent (4-propylbenzoic acid) are added to the dispersion of zirconium oxide in dimethylacetamide so that the weight ratios of ZrO₂ solid component/PL-1/4-propylbenzoic acid becomes 41.7/8.3/8.3 and, after stirring to uniformly mix, the dimethylacetamide solvent is removed by heating under reduced pressure. This concentrated solution is used as a solution of the nanocomposite material.

### Example 1

The above-prepared solution is dried by spray-drying in the spray drying apparatus shown in FIG. 2 to obtain a powder body. In this occasion, the solution concentration is 30% by weight, and the temperature in the drying chamber is 145° C. The thus-obtained powder body is subjected to vacuum drying in the vacuum drying apparatus shown in FIG. 4. The pressure upon drying is set to be 0.1 Pa, the vacuum drying temperature is set to be 80° C., and the vacuum drying time is set to be 12 hours.

### Example 2

The above-prepared solution is dried by atomizing the solution into droplets by means of the inkjet mechanism shown in FIG. 6 to obtain a powder body. In this occasion, the solution concentration is 30% by weight, and the diameter of the droplets is 0.4 mm (32 pL). The thus-obtained powder body is subjected to vacuum drying in the vacuum drying apparatus shown in FIG. 4. The conditions upon vacuum drying are the same as in Example 1, with the pressure being set to be 0.1 Pa, the vacuum drying temperature being set to be 80° C., and the vacuum drying time being set to be 12 hours.

### Example 3

The above-prepared solution is freeze-dried in the freeze-drying apparatus shown in FIG. 8 to form a preform of a lens precursor. In this occasion, the solution concentration is 30% by weight, and the vacuum drying time is set to be 50 hours.

### Example 4

As in Example 3, the solution is freeze-dried in a 0.5-mm thick film state in the freeze-drying apparatus. In this occasion, the solution concentration is 30% by weight, and the vacuum drying time is set to be 10 hours.

### Example 5

The solution is freeze-dried as in Example 4 in an extremely thin film state by spraying the solution as droplets using the freeze-drying apparatus. In this occasion, the solution concentration is 30% by weight, and the vacuum drying time is set to be 5 hours.

### Comparative Examples 1-1, 1-2

A preforme of the same shape as that formed in Example 3 is prepared by concentration drying. In this occasion, the vacuum drying treatment is conducted under the conditions of 0.1 Pa in pressure, 80° C. in temperature, and 24 hours in vacuum drying temperature in Comparative Example 1-1 or 240 hours in Comparative Example 1-2.

### Comparative Examples 2-1, 2-2

A preforme of the same shape as that formed in Example 3 is prepared by concentration drying. In this occasion, the vacuum drying treatment is conducted under the conditions of 0.1 Pa in pressure, 80° C. in temperature, and 24 hours in vacuum drying temperature in Comparative Example 2-1 or 240 hours in Comparative Example 2-2.

The specific surface areas and the residual amounts of the solvents of the moldings prepared in Examples 1 to 5 and Comparative Examples 1-1 to 1-2, 2-1 to 2-2 are shown in Table 3 together with the drying times.

TABLE 3

| | Drying Time (In | | |
|---|---|---|---|
| | Vacuum | Specific Surface | Amount of |
| | State) [hours] | Area [mm−1] | Residual Solvent |
| Example 1 | 12 | 100 | 0.98 |
| Example 2 | 12 | 15 | 1.45 |
| Example 3 | 50 | 500 | 0.26 |
| Example 4 | 10 | 520 | 0.24 |
| Example 5 | 5 | 550 | 0.20 |
| Comparative | 24 | 2 | 5.32 |
| Example 1-1 | | | |
| Comparative | 240 | 2 | 2.51 |
| Example 1-2 | | | |
| Comparative | 24 | 13 | 3.50 |
| Example 2-1 | | | |
| Comparative | 240 | 13 | 1.60 |
| Example 2-2 | | | |

As is apparent from Table 3, in the concentration drying treatment as in Comparative Examples 1-1 and 1-2, the specific surface area is reduced to 13 mm⁻¹ or less, and the amount of the residual solvent cannot be sufficiently reduced. Also, in order to dry to a sufficient level, the drying time is seriously prolonged as in Comparative Examples 1-2 and 2-2. On the other hand, in Examples 1 to 5, the specific surface area is increased to 15 mm⁻¹ or more, and the amount of the residual solvent can be sufficiently reduced in a short drying time.

Here, the amounts of the residual solvents shown in the above table are the results obtained by measuring by means of a gas chromatography GC/MS having the ability of mass analysis, and the specific surface areas are the results obtained by measuring using a specific surface area-measuring apparatus (Gemini 2380; manufactured by Shimadzu Mfg. Works).

### INDUSTRIAL APPLICABILITY

As is described hereinbefore, the process of the present invention for producing an optical member enables one to produce an optical member with high quality by using a nanocomposite material having a large refractive index, and hence it has an extremely high use value in producing an optical member such as a small-sized lens which can be utilized in a mobile camera.

The present application claims foreign priority based on Japanese Patent Application No. JP2007-240875 filed Sep. 18, 2007, the contents of which is incorporated herein by reference.

1. A method for producing an optical member from a nanocomposite material which includes a thermoplastic resin containing inorganic fine particles,
the method comprising:
a first step of preparing in a solution the thermoplastic resin containing the inorganic fine particles;
a second step of drying and solidifying the solution containing the prepared thermoplastic resin to produce the nanocomposite material having a specific surface area of 15 mm⁻¹ or more; and
a third step of heat-compressing the produced nanocomposite material to form the optical member in a desired shape.

2. The method according to claim 1, wherein the drying and solidifying is conducted to a droplet of the solution of the thermoplastic resin containing the inorganic fine particles.

3. The method for producing an optical member according to claim 2, wherein the drying and solidifying is conducted by continuously ejecting the droplet of the solution through a spray nozzle in a pressurized state.

4. The method according to claim 2, wherein the drying and solidifying is conducted by repeatedly ejecting the droplet of the solution through a nozzle of an inkjet head.

5. The method according to claim 4, wherein the ejecting of the droplet is repeated until an amount of the solution reaches a volume of at least one optical member to be formed by the heat-compressing in the third step.

6. The method according to claim 2, wherein the droplet of the solution has a diameter of 0.5 mm or less.

7. The method according to claim 1, wherein the drying and solidifying is conducted by freeze-drying the solution the solution of the thermoplastic resin containing the inorganic fine particles.

8. The method according to claim 7, wherein the drying and solidifying is conducted by: weighing an enough amount of the solution of the thermoplastic resin containing the inorganic fine particles to form one optical member; and freeze-drying the solution in a mold having a smaller inner size than that of the optical member.

9. The method according to claim 1, wherein the heat-compressing of the nanocomposite material is conducted in vacuum state, in a carbon dioxide gas, or in a nitrogen gas.

10. The method according to claim 1, wherein the optical member is a lens or a lens precursor.

11. An optical member produced by a method according to claim 1.
